(19) United States
(12) Patent Application Publication
(10) Pub. No.: US 2013/0252817 A1
(43) Pub. Date: Sep. 26, 2013

(54) AQUEOUS HERBICIDE CONCENTRATES CONTAINING FATTY ACID ALKYL ESTERS, FATTY ACID AMIDES, OR TRIGLYCERIDE FATTY ACID ESTERS AND METHODS OF USE

(71) Applicants: Hui Shao, Carmel, IN (US); Hong Zhang, Carmel, IN (US); Holger Tank, Zionsville, IN (US); Mei Li, Westfield, IN (US); Kuide Qin, Westfield, IN (US); Lei Liu, Carmel, IN (US); Stephen L. Wilson, Zionsville, IN (US)

(72) Inventors: Hui Shao, Carmel, IN (US); Hong Zhang, Carmel, IN (US); Holger Tank, Zionsville, IN (US); Mei Li, Westfield, IN (US); Kuide Qin, Westfield, IN (US); Lei Liu, Carmel, IN (US); Stephen L. Wilson, Zionsville, IN (US)

(73) Assignee: Dow AgroSciences LLC, Indianapolis, IN (US)

(21) Appl. No.: 13/827,215

(22) Filed: Mar. 14, 2013

Related U.S. Application Data
(60) Provisional application No. 61/614,663, filed on Mar. 23, 2012.

(51) Int. Cl. A01N 25/00

(52) U.S. Cl. CPC A01N 25/00
USPC 504/206; 504/362; 504/254; 504/324; 504/323

(57) ABSTRACT

Aqueous herbicide concentrates containing a herbicide (such as an auxinic herbicide), a surfactant, and a fatty acid alkyl ester, a fatty acid amide, and/or a triglyceride fatty acid ester and the use of aqueous herbicide spray mixtures incorporating such concentrates are described. The aqueous herbicide concentrates described herein include from 5 to 90 weight percent of a water soluble salt of a herbicide, from 0.1 to 20 weight percent of a surfactant, and from 0.1 to 20 weight percent of a fatty acid alkyl ester, fatty acid amide, and/or a triglyceride fatty acid ester. The aqueous herbicide concentrate is a transparent, homogeneous liquid that forms a stable emulsion upon dilution into a spray solution.

This application claims the benefit of U.S. Provisional Patent Application Ser. No. 61/614,663, filed Mar. 23, 2012.

### BACKGROUND

Agricultural spraying by economical and available technologies uses hydraulic spray nozzles that inherently produce a wide spectrum of spray droplet sizes. The potential for these spray droplets to drift from the initial, desired site of application is found to be a function of droplet size, with smaller droplets having a higher propensity for off-target movement. Significant research efforts, involving numerous field trials, wind tunnel tests and subsequent generation of predictive math models have led to a greatly enhanced understanding of the relationship between spray droplet size and potential for off-target drift. Although other factors such as meteorological conditions and spray boom height contribute to the potential for drift, spray droplet size distribution has been found to be a predominant factor. Teske et. al. (Teske M. E., Hewitt A. J., Valcore, D. L. 2004. The Role of Small Droplets in Classifying Drop Size Distributions ILASS Americas 17^{th} Annual Conference: Arlington Va.) have reported a value of <156 microns (μm) as the fraction of the spray droplet distribution that contributes to drift Robert Wolf (Wolf R. E., Minimizing Spray Drift, Dec. 15, 1997, Microsoft® PowerPoint Presentation, available at www.bae.ksu.edu/faculty/wolf/drift.htm, last viewed Jan. 26, 2012) cites a value of <200 μm as the driftable fraction. A good estimation of droplet size likely to contribute to drift, therefore, is the fraction below about 150 μm.

The negative consequences of off-target movement can be quite pronounced. Some herbicides have demonstrated very sensitive phytotoxicity to particular plant species at extremely low parts per million (ppm) or even parts per billion (ppb) levels, resulting in restricted applications around sensitive crops, orchards, and residential plantings. For example, the California Dept of Pesticide Regulation imposes buffers of ½-2 miles for propanil containing herbicides applied aerially in the San Joaquin valley.

### SUMMARY

The methods and compositions described herein include aqueous concentrates containing a water soluble salt of a herbicide, a surfactant, and a fatty acid alkyl ester, a tatty acid amide, and/or a triglyceride fatty acid ester and the use of aqueous herbicide spray mixtures incorporating such concentrates. The aqueous herbicide concentrates described herein include from 5 to 90 weight percent of a water soluble salt of a water soluble salt of a herbicide, from 0.1 to 20 weight percent of a surfactant, and from 0.1 to 20 weight percent of a fatty acid alkyl ester of Formula I:

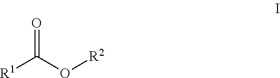

a fatty acid amide of Formula II:

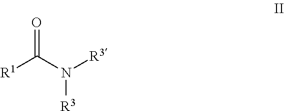

and/or a triglyceride fatty acid ester of Formula III:

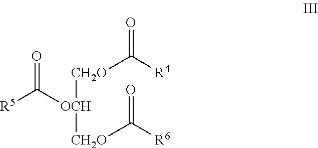

In Formulas I, II, and III, R¹ represents a saturated or unsaturated straight chain (C₆-C₂₁)alkyl, R² represents a straight or branched chain (C₁-C₆)alkyl, R³ and R^{3′} independently represent hydrogen, a straight or branched chain (C₁-C₆)alkyl, or a straight or branched chain (C₁-C₆) heteroalkyl, and R⁴, R⁵, and R⁶ independently represent saturated or unsaturated (C₆-C₂₁)alkyls. These aqueous herbicide concentrates are transparent, homogeneous liquids that form a stable emulsion upon dilution into a spray solution. The methods for reducing spray drift during herbicide spray application to control plant growth include providing an aqueous herbicide concentrate as described, adding the aqueous herbicide concentrate to a spray tank containing water to form a stable emulsion, and spraying the stable emulsion to control plant growth.

### DETAILED DESCRIPTION

Methods and compositions to reduce spray drift are described herein. The methods and compositions reduce the amount of driftable fines of a herbicide spray in both aerial and ground spray applications. The methods include the use of aqueous herbicide spray mixtures incorporating a fatty acid alkyl ester, fatty acid amide, and/or a triglyceride fatty acid ester and one or more herbicides. As used herein the terms fatty acid alkyl ester and fatty acid amide refers to fatty acid alkyl esters and fatty acid amides of Formulas I and II:

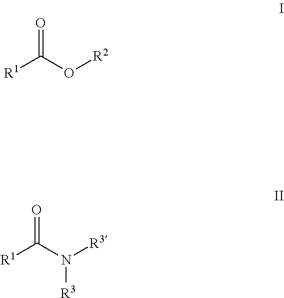

Where R¹ represents a saturated or unsaturated straight chain (C₆-C₂₁)alkyl, R² represents a straight or branched chain (C₁-C₆)alkyl, and R³ and R^{3′} independently represent hydrogen, a straight or branched chain (C₁-C₆)alkyl, or a straight or branched chain (C₁-C₆) heteroalkyl. In Formula II, R³ and R^{3′} can combine to form a heterocyclic group such as a morpholine group (sec FIG. IIa), a piperidine group (see FIG. IIb), or a pyrrolidine group (see FIG. IIc).

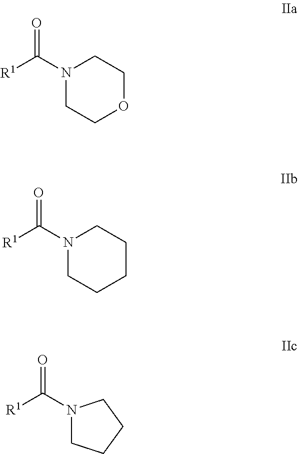

Also, as used herein the tert triglyceride fatty acid ester refers to a triglyceride fatty acid ester of Formula III:

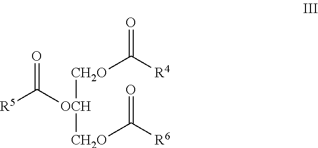

Where R⁴, R⁵, and R⁶ independently represent saturated or unsaturated straight or branched chain (C₆-C₂₁)alkyls. The aqueous herbicide concentrates as described herein include from 5 to 90 weight percent of a water soluble salt of a herbicide, from 0.1 to 20 weight percent of a surfactant; and from 0.1 to 20 weight percent of the fatty acid alkyl esters, fatty acid amides, and/or the triglyceride fatty acid esters described herein. The aqueous herbicide concentrates as described herein are transparent, homogeneous liquids that form a stable emulsion upon addition to water.

Herbicides useful with the methods and compositions described herein include, for example, auxinic herbicides. Auxinic herbicides useful with the methods and compositions described herein include, for example, clopyralid, triclopyr, 2,4-D, 2,4-DB, MCPA, aminocyclopyrachlor, aminopyralid, dicamba, halauxifen, picloram, or mixtures thereof. The methods described herein are most particularly useful for the application of herbicides that are subject to restricted applications around sensitive crops such as spray mixtures containing glyphosate, 2,4-D, triclopyr, dicamba, or mixtures thereof.

Fatty acid alkyl esters, fatty acid amides, and/or triglyceride fatty acid esters useful with the methods and compositions described herein may be derived from or made from plant or animal sources and include, for example, vegetable oil, seed oil, or animal oil, or monoesters derived from vegetable, seed, or animal oils, or mixtures thereof. Examples of fatty acid alkyl esters useful with the methods and composition described herein include methyl caproate, methyl caprylate, methyl caprate, methyl laurate, methyl myristate, methyl palmitate, methyl stearate, methyl oleate, methyl linoleate, methyl linolenate, and mixtures thereof. Examples of fatty acid amides useful with the methods and composition described herein include N,N-dimethylcaprylamyde (N,N-dimethyloctanamide), N,N-dimethylcapramide (N,N-dimethyldecanamide), and mixtures thereof, which are available commercially as Agnique® AMD 810 and Agnique® AMD 10 (BASF-Cognis; Cincinnati, Ohio), and the morpholine amide of caprylic/capric fatty acids which is commercially available as JEFFSOL® AG-1730 Solvent (Huntsman international LLC; The Woodlands, Tex.). Examples of triglyceride fatty acid esters useful with the methods and composition described herein include vegetable or a seed oils selected from soybean oil, rape seed oil, olive oil, almond oil, canola oil, omega-9 canola oil, castor oil, sunflower seed oil, coconut oil, corn oil, cotton seed oil, linseed oil, palm oil, peanut oil, safflower oil, sesame oil, tung oil, and mixtures thereof.

The surfactants useful with the methods and compositions described herein may be phosphate ester surfactants, polymeric surfactants, or mixtures thereof and may be anionic or nonionic in character. Examples of useful surfactants include ABA block copolymers; polyvinyl alcohol resins; block or graft acrylate or methacrylate copolymers; alkyd polyethylene oxide resins; AB block copolymers containing EO and PO blocks such as ethylene oxide-propylene oxide (EO-PO) block copolymers; alcohol alkoxylates; acids or salts of mono and dialkyl phosphate esters; acids or salts of ethoxylated mono and dialkyl phosphate esters; acids or salts of mono and dialkyl phosphate esters of ethoxylated tristyrylphenol; acids or salts of mono and dialkyl phosphate esters of ethoxylated phenol and ethoxylated arkylphenols; and mixtures thereof.

Examples of useful phosphate ester surfactants include: Atlox™ DP13/6, Cresplus™ 1209, Crodafos™ 810A, Crodafos™ 810D, Crodafos™ CO5A, Crodafos™ CS2A, Crodafos™ D4A, Crodafos™ 626A, Crodafos™ O10A, Crodafos™ O3A, Multitrope 1214, Crodafos™ T5A, and Crodafos™ T6A (all from Croda; Edison, N.J.), Cedephos FA-600, Petrostep® PE-70T, Polystep® P-12A, Polystep® P-33, Polystep® TSP-16PE, Stepan® MWA-311, Stepfac 8170, Stepfac 8171, Stepfac 8173, Stepfac 8175, Stepfac 8180, Stepfac 8181, Stepfac TSP-PE, Stepfac TSP-PE-K, Stepfac TSP-PE-N, Zelec® AN and Zelec® LA-2 (all from Stepan; Northfield, Ill.), Klearfac® AA 270, Maphos® 58, Maphos® 60 A, Maphos® 66 H, Maphos® M 60, Agnique® PE 2EH-2k, Agnique® PE NP-4, Agnique® PE NP-6, Agnique® PE NP-9, Agnique® PE DNP-8, Agnique® PE IDA-6, Agnique® PE TDA-6, Agnique® PE 25, Agnique® PE 28, Agnique® PE 28-9N and Agnique® PE 68-5 (all from BASF; Florham Park, N.J.), Duraphos 100, Duraphos 178, Lubrhophos LB 400, Lubrhophos LB/400-E, Lubrhophos LP/700 E, Lubrhophos RD/510-E, Rhodafac® AAP, Rhodafac® BN-936/S, Rhodafac® HA70, Rhodafac® LO-11/ALA, Rhodafac® LO/529-E, Rhodafac® PA 15, Rhodafac® PA 23, Rhodafac® PA 35, Rhodafac® PA/32, Rhodafac® PE 510, Rhodafac® RM 710, Rhodafac® RM/510-E, Rhodafac® RS 410, Rhodafac® RS 610-E, Rhodafac® RS 710, Rhodafac® RS-610/A25, Rhodafac® RS/710-E, Soprophor® 3 D 33, Trimethyl Phosphite HP and Trimethyl Phosphite (all from Rhodia; Cranberry, N.J.), and the SURFONIC® PE series and the EMPIPHOS® series (both from Huntsman International LLC; The Woodlands, Tex.). The phosphate ester surfactant can be present in an amount from 1 g/kg to 200 g/kg, preferably from 1 g/kg to 100 g/kg of the total composition.

Examples of useful polymeric surfactants include: (1) ABA block copolymers having a hydrophilic portion of polyethylene oxide and a hydrophobic portion of poly(12-hydroxystearate), such as, for example, Atlox™ 4912 (Croda; Edison, N.J.), having a molecular weight of about 5,000 and Termul™ 2510 (Huntsman International LLC; The Woodlands, Tex.); (2) polyvinyl alcohol resins with a degree of hydrolysis of 86-89%, such as, for example, Gohsenol GL03 and Gohsenol G-L05 (The Nippon Synthetic Chemical Industry Co., Ltd.; Osaka, Japan); (3) methyl methacrylate graft copolymers, such as, for example, Atlox™ 4913 (Croda; Edison, N.J.); (4) alkyd polyethylene oxide resins, such as, for example, Atlox™ 4914 (Croda; Edison, N.J.) and the like; (5) EO-PO block copolymers, such as, for example, Atlas™ G-5000 (Croda; Edison, N.J.), and the Pluronic® block copolymers (BASF; Florham Park, N.J.), and the like; (6) alcohol alkoxylates, such as, for example, Termul™ 5429 (Huntsman International LLC; The Woodlands, Tex.). Especially useful polymeric surfactants include the ABA block copolymers and EO-PO block copolymers. The polymeric surfactant can be present in an amount from 1 g/kg to 200 g/kg, preferably from 1 g/kg to 50 g/kg of the total composition.

The aqueous herbicide spray mixtures disclosed herein may include insecticides, herbicides, herbicide safeners, or fungicides and the aqueous herbicide spray mixtures may be applied for the control of unwanted plants, fungi, or insects at levels dependent on the concentration of the active ingredient needed to control the target pest.

The aqueous herbicide spray mixtures as described herein may be applied in conjunction with one or more other active ingredients to control a wider variety of unwanted plants, fungi, or insects. When used in conjunction with the other active ingredients, the presently claimed compositions can be formulated with the other active ingredient or active ingredients as premix concentrates, tank mixed with the other active ingredient or active ingredients for spray application, or applied sequentially with the other active ingredient or active ingredients in separate spray applications.

An example of a composition as described herein that may be used in conjunction with another active ingredient comprises an aqueous pre-mix concentrate containing a mixture of an auxinic herbicide such as a water soluble salt of 2,4-D, a water soluble salt of triclopyr, a water soluble salt of dicamba, or mixtures thereof, and a fatty acid alkyl ester, fatty acid amide, and/or triglyceride fatty acid ester. Such aqueous pre-mix herbicidal concentrates may be diluted from 1 to 2000 fold in water at the point of use depending on the agricultural practices and used in spray applications to control weeds in crops.

In some situations, the aqueous herbicide spray mixtures may contain one or more biocides. Biocides may be present in the composition from about 0.001 wt % to about 0.1 wt %. In embodiments, the one or more biocides may be present in the composition at 0.001 wt %, 0.005 wt %, 0.01 wt %, 0.02 wt %, 0.03 wt %, 0.04 wt %, 0.05 wt %, 0.06 wt %, 0.07 wt %, 0.08 wt %, 0.09 wt %, or 0.1 wt %. Examples of biocides include, but are not limited to, bactericides, viricides, fungicides, parasiticides, and the like. Examples of biocide active ingredients include, but are not limited to, phenol compounds (such as phenol, thymol, pentachlorophenol, cresol, and p-chloro-m-xylenol), aldehydic compounds (such as formaldehyde, glutaraldehyde, and paraformaldehyde), acid compounds (such as benzoic acid, sorbic acid, mucochloric acid, and mucobromic acid), esters of p-hydroxybenzoic acid (such as methyl-p-hydroxybenzoate and butyl-p-hydroxybenzoate), rare earth salts, amines, disulfides, heterocyclic compounds (such as thiazinium salts, thiazolinones, and benzimidazoles), quaternary ammonium salts, organic mercury compounds, hexamethylenebiguanide hydrochlorides, benzalkonium chlorides, polyamino propylbiguanides, and 1-2-benzisothiazoline-3-ones. For specific example, an aqueous herbicide spray mixture may comprise Proxer® GXL, (Arch Chemicals Inc., Atlanta, Ga.) as a biocide.

Suitable active ingredients for use in the aqueous herbicide spray mixtures described herein include herbicides such as, for example, auxinic herbicides (such as 2,4-D, 2,4-DB, aminopyralid, aminocyclopyrachlor, clopyralid, dicamba, fluoroxypyr, halauxifen, MCPA, MCPB, picloram or triclopyr), acetochlor, atrazine, benfluralin, cloransulam, cyhalofop, diclosulam, dithiopyr, ethalfluralin, florasulam, flumetsulam, glufosinate, glyphosate, haloxyfop, isoxaben, MSMA, oryzalin, oxyfluorfen, pendimethalin, penoxsulam, propanil, pyroxsulam, quizalofop, tebuthiuron, and trifluralin. Suitable active ingredients for use in the described compositions also include herbicide safeners such as, for example, cloquintocet, flurazole, mefenpyr, and TI-35. Suitable active ingredients for use in the described compositions also include insecticides such as, for example, chlorpyrifos, chlorpyrifos methyl, gamma-cyhalothrin, cypermethrin, deltamethrin, halofenozide, methoxyfenozide, sulfoxaflor, spinosad, spinetoram, and tebufenozide. Suitable active ingredients for use in the described compositions also include fungicides such as, for example, fenbuconazole, mancozeb, myclobutanil, propiconazole, quinoxyfen, thifluzamide, and zoxamide.

When the aqueous herbicide spray mixtures described herein contain water soluble salts of auxinic herbicides and/or the water soluble salt of glyphosate, suitable cations contained in these salts include isopropyl ammonium, dimethyl ammonium, triethyl ammonium, monoethanol ammonium, diethanol ammonium, triethanol ammonium; dimethylethanol ammonium, diethyleneglycol ammonium, triisopropanol ammonium, tetramethyl ammonium, tetraethyl ammonium, choline, and potassium. For example, useful 2,4-D salts include the 2,4-D choline salt and the 2,4-D dimethyl ammonium salt, and useful glyphosate salts include the glyphosate dimethyl ammonium salt, the glyphosate isopropyl ammonium salt, and the glyphosate potassium salt.

In an example of an aqueous herbicide spray mixture, the herbicide is an auxinic herbicide and the auxinic herbicide is 2,4-D choline salt or 2,4-D dimethyl ammonium salt and the glyphosate is glyphosate dimethyl ammonium salt, glyphosate isopropyl ammonium salt, or glyphosate potassium salt. In another example of an aqueous herbicide spray mixture, the herbicide is an auxinic herbicide and the auxinic herbicide is 2,4-D choline salt or 2,4-D dimethyl ammonium salt, the glyphosate is glyphosate dimethyl ammonium salt, glyphosate isopropyl ammonium salt, or glyphosate potassium salt, and the fatty acid alkyl ester, fatty acid amide, and/or triglyceride fatty acid ester is methyl caproate, methyl caprylate, methyl caprate, methyl laurate, methyl myristate, methyl palmitate, methyl stearate, methyl oleate, methyl linoleate, methyl linolenate, N,N-dimethylcaprylamide (N,N-dimethyloctanamide), N,N-dimethylcapramide (N,N-dimethyldecanamide), soybean oil, rapeseed oil, olive oil, almond oil, canola oil, omega-9 canola oil, castor oil, sunflower seed oil, coconut oil, corn oil, cotton seed oil, linseed oil, palm oil, peanut oil, safflower oil, sesame oil, tung oil, or mixtures thereof. In a further example of an aqueous herbicide spray mixture, the herbicide is an auxinic herbicide and the auxinic herbicide is 2,4-D choline salt, the glyphosate is glyphosate dimethyl ammonium salt, and the fatty acid alkyl ester, fatty acid amide, and/or triglyceride fatty acid ester is methyl caproate, methyl caprylate, methyl caprate, methyl laurate, methyl myristate, methyl palmitate, methyl stearate, methyl oleate, methyl linoleate, methyl linolenate, N,N-dimethylcaprylamide (N,N-dimethyloctanamide), N,N-dimethylcapramide (N,N-dimethyldecanamide), morpholine caprylaminde, morpholine capramide, soybean oil, rapeseed oil, olive oil, castor oil, sunflower seed oil, almond oil, canola oil, omega-9 canola oil, coconut oil, corn oil, cotton seed oil, linseed oil, palm oil, peanut oil, safflower oil, sesame oil, lung oil, or mixtures thereof.

The optimum spray droplet size depends on the application for which the herbicide composition is used. If droplets are too large, there will be less coverage by the spray; i.e, large droplets will land in certain areas while areas in between will receive little or no spray coverage. The maximum acceptable droplet size may depend on the amount of composition being applied per unit area and the need for uniformity in spray coverage. Smaller droplets provide more even coverage, but are more prone to drift during spraying. Thus, application parameters such as uniformity in spray coverage must be balanced against the tendency for smaller droplets to drift. For example, if it is particularly windy during spraying, larger droplets may be needed to reduce drift, whereas on a calmer day smaller droplets may be acceptable.

In addition to the physical properties of a particular aqueous herbicide composition, spray droplet size may also depend on the spray apparatus, e.g., nozzle size and configuration. The reduction in spray drift may result from a variety of factors including a reduction in the production of fine spray droplets (<150 μm minimum diameter) and an increase in the volume median diameter (VMD) of the spray droplets. In any event, for a given spray apparatus, application, and conditions, and based on the fatty acid alkyl ester, fatty acid amide, and/or triglyceride fatty acid ester, the median diameter of the plurality of spray droplets created using the compositions and methods described herein is increased above that of a spray composition that does not include the fatty acid alkyl ester, fatty acid amide, or triglyceride fatty acid ester as described herein.

In addition to the methods described above, aqueous herbicide concentrate compositions are also described. As used herein aqueous herbicide concentrate compositions are solutions containing high concentrations of an aqueous herbicide spray component described above, i.e., one or more water soluble herbicide salts and a fatty acid alkyl ester, fatty acid amide, and/or triglyceride fatty acid ester. The aqueous concentrate compositions are intended to be diluted to provide aqueous herbicide spray mixtures for use, for example, with the methods described herein.

The aqueous concentrate compositions described herein include from 5 to 90 weight percent of one or more water soluble salts of a herbicide. Additional examples of concentrations for the herbicide incorporated into the aqueous herbicide concentrate mixture described herein include, from 5 to 85 weight percent of the concentrate mixture, from 5 to 80 weight percent of the concentrate mixture, from 5 to 75 weight percent of the concentrate mixture, from 5 to 70 weight percent of the concentrate mixture, from 5 to 65 weight percent of the concentrate mixture, from 5 to 60 weight percent of the concentrate mixture, from 5 to 55 weight percent of the concentrate mixture, from 5 to 50 weight percent of the concentrate mixture, from 5 to 45 weight percent of the concentrate mixture, from 5 to 40 weight percent of the concentrate mixture, from 5 to 35 weight percent of the concentrate mixture, from 5 to 30 weight percent of the concentrate mixture, from 5 to 25 weight percent of the concentrate mixture, and from 5 to 20 weight percent of the concentrate mixture. Further examples of concentrations for the herbicide incorporated into the aqueous herbicide concentrate mixture described herein include, from 10 to 90 weight percent of the concentrate mixture, from 15 to 90 weight percent of the concentrate mixture, from 20 to 90 weight percent of the concentrate mixture, from 25 to 90 weight percent of the concentrate mixture, from 30 to 90 weight percent of the concentrate mixture, from 35 to 90 weight percent of the concentrate mixture, from 40 to 90 weight percent of the concentrate mixture, from 45 to 90 weight percent of the concentrate mixture, from 50 to 90 weight percent of the concentrate mixture, from 55 to 90 weight percent of the concentrate mixture, from 60 to 90 weight percent of the concentrate mixture, from 65 to 90 weight percent of the concentrate mixture, from 70 to 90 weight percent of the concentrate mixture, from 75 to 90 weight percent of the concentrate mixture, from 80 to 90 weight percent of the concentrate mixture, and from 85 to 90 weight percent of the concentrate mixture. More examples of concentrations for the herbicide incorporated into the aqueous herbicide concentrate mixture described herein include, from 10 to 85 weight percent of the concentrate mixture, from 15 to 80 weight percent of the concentrate mixture, from 20 to 75 weight percent of the concentrate mixture, from 25 to 75 weight percent of the concentrate mixture, from 30 to 70 weight percent of the concentrate mixture, from 35 to 65 weight percent of the concentrate mixture, from 40 to 60 weight percent of the concentrate mixture, from 45 to 60 weight percent of the concentrate mixture, from 40 to 55 weight percent of the concentrate mixture, and from 45 to 55 weight percent of the concentrate mixture.

The aqueous concentrate compositions described herein include from 0.1 to 20 weight percent of a surfactant. Additional examples of concentrations for the surfactant incorporated into the aqueous herbicide concentrate mixture described herein include, from 0.1 to 19 weight percent of the concentrate mixture, from 0.1 to 18 weight percent of the concentrate mixture, from 0.1 to 17 weight percent of the concentrate mixture, from 0.1 to 16 weight percent of the concentrate mixture, from 0.1 to 15 weight percent of the concentrate mixture, from 0.1 to 14 weight percent of the concentrate mixture, from 0.1 to 13 weight percent of the concentrate mixture, from 0.1 to 12 weight percent of the concentrate mixture, from 0.1 to 11 weight percent of the concentrate mixture, from 0.1 to 10 weight percent of the concentrate mixture, from 0.1 to 9 weight percent of the concentrate mixture, from 0.1 to 8 weight percent of the concentrate mixture, from 0.1 to 7 weight percent of the concentrate mixture, from 0.1 to 6 weight percent of the concentrate mixture, from 0.1 to 5 weight percent of the concentrate mixture, from 0.1 to 4.5 weight percent of the concentrate mixture, from 0.1 to 4 weight percent of the concentrate mixture, from 0.1 to 3.5 weight percent of the concentrate mixture, from 0.1 to 3 weight percent of the concentrate mixture, from 0.1 to 2.5 weight percent of the concentrate mixture, from 0.1 to 2 weight percent of the concentrate mixture, from 0.1 to 1.5 weight percent of the concentrate mixture, and from 0.1 to 1 weight percent of the concentrate mixture. Further examples of concentrations for the surfactant incorporated into the aqueous herbicide concentrate mixture described herein include, from 0.2 to 20 weight percent of the concentrate mixture, from 0.3 to 20 weight percent of the concentrate mixture, from 0.1 to 20 weight percent of the concentrate mixture, from 0.5 to 20 weight percent of the concentrate mixture, from 0.6 to 20 weight percent of the concentrate mixture, from 0.7 to 20 weight percent of the concentrate mixture, from 0.8 to 20 weight percent of the concentrate mixture, from 0.9 to 20 weight percent of the concentrate mixture, from 1 to 20 weight percent of the concentrate mixture, from 1.5 to 20 weight percent of the concentrate mixture, from 2 to 20 weight percent of the concentrate mixture, from 3 to 20 weight percent of the concentrate mixture, from 4 to 20 weight percent of the concentrate mixture, from 5 to 20 weight percent of the concentrate mixture, from 6 to 20 weight percent of the concentrate mixture, from 7 to 20 weight percent of the concentrate mixture, from 8 to 20 weight percent of the concentrate mixture, from 9 to 20 weight percent of the concentrate mixture, from 10 to 20 weight percent of the concentrate mixture, from 11 to 20 weight percent of the concentrate mixture, from 12 to 2.0 weight percent of the concentrate mixture, from 13 to 20 weight percent of the concentrate mixture, from 14 to 20 weight percent of the concentrate mixture, from 15 to 20 weight percent of the concentrate mixture, from 16 to 20 weight percent of the concentrate mixture, from 17 to 20 weight percent of the concentrate mixture, from 18 to 20 weight percent of the concentrate mixture, and from 19 to 20 weight percent of the concentrate mixture. More examples of concentrations for the surfactant incorporated into the aqueous herbicide concentrate mixture described herein include, from 0.2 to 19 weight percent of the concentrate mixture, from 0.3 to 18 weight percent of the concentrate mixture, from 0.4 to 17 weight percent of the concentrate mixture, from 0.5 to 16 weight percent of the concentrate mixture, from 0.6 to 15 weight percent of the concentrate mixture, from 0.7 to 14 weight percent of the concentrate mixture, from 0.8 to 13 weight percent of the concentrate mixture, from 0.9 to 12 weight percent of the concentrate mixture, from 1 to 11 weight percent of the concentrate mixture, from 2 to 10 weight percent of the concentrate mixture, from 2 to 9 weight percent of the concentrate mixture, from 2 to 8 weight percent of the concentrate mixture, from 2 to 7 weight percent of the concentrate mixture, from 2 to 6 weight percent of the concentrate mixture, from 2 to 5 weight percent of the concentrate mixture, from 2 to 4 weight percent of the concentrate mixture, and from 2 to 3 weight percent of the concentrate mixture.

The aqueous concentrate compositions described herein include from 0.1 to 20 weight percent of a fatty acid alkyl ester, fatty acid amide, and/or triglyceride fatty acid ester. Additional examples of concentrations for the a fatty acid alkyl ester, fatty acid amide, and/or triglyceride fatty acid ester incorporated into the aqueous herbicide concentrate mixture described herein include, from 0.1 to 19 weight percent of the concentrate mixture, from 0.1 to 18 weight percent of the concentrate mixture, from 0.1 to 17 weight percent of the concentrate mixture, from 0.1 to 16 weight percent of the concentrate mixture, from 0.1 to 15 weight percent of the concentrate mixture, from 0.1 to 14 weight percent of the concentrate mixture, from 0.1 to 13 weight percent of the concentrate mixture, from 0.1 to 12 weight percent of the concentrate mixture, from 0.1 to 11 weight percent of the concentrate mixture, from 0.1 to 10 weight percent of the concentrate mixture, from 0.1 to 9 weight percent of the concentrate mixture, from 0.1 to 8 weight percent of the concentrate mixture, from 0.1 to 7 weight percent of the concentrate mixture, from 0.1 to 6 weight percent of the concentrate mixture, from 0.1 to 5 weight percent of the concentrate mixture, from 0.1 to 4.5 weight percent of the concentrate mixture, from 0.1 to 4 weight percent of the concentrate mixture, from 0.1 to 3.5 weight percent of the concentrate mixture, from 0.1 to 3 weight percent of the concentrate mixture, from 0.1 to 2.5 weight percent of the concentrate mixture, from 0.1 to 2 weight percent of the concentrate mixture, from 0.1 to 1.5 weight percent of the concentrate mixture, and from 0.1 to 1 weight percent of the concentrate mixture. Further examples of concentrations for the fatty acid alkyl ester, fatty acid amide, and/or triglyceride fatty acid ester incorporated into the aqueous herbicide concentrate mixture described herein include, from 0.2 to 20 weight percent of the concentrate mixture, from 0.3 to 20 weight percent of the concentrate mixture, from 0.4 to 20 weight percent of the concentrate mixture, from 0.5 to 20 weight percent of the concentrate mixture, from 0.6 to 20 weight percent of the concentrate mixture, from 0.7 to 20 weight percent of the concentrate mixture, from 0.8 to 20 weight percent of the concentrate mixture, from 0.9 to 20 weight percent of the concentrate mixture, from 1 to 20 weight percent of the concentrate mixture, from 1.5 to 20 weight percent of the concentrate mixture, from 2 to 20 weight percent of the concentrate mixture, from 3 to 20 weight percent of the concentrate mixture, from 4 to 20 weight percent of the concentrate mixture, from 5 to 20 weight percent of the concentrate mixture, from 6 to 20 weight percent of the concentrate mixture, from 7 to 20 weight percent of the concentrate mixture, from 8 to 20 weight percent of the concentrate mixture, from 9 to 20 weight percent of the concentrate mixture, from 10 to 20 weight percent of the concentrate mixture, from 11 to 20 weight percent of the concentrate mixture, from 12 to 20 weight percent of the concentrate mixture, from 13 to 20 weight percent of the concentrate mixture, from 14 to 20 weight percent of the concentrate mixture, from 15 to 20 weight percent of the concentrate mixture, from 16 to 20 weight percent of the concentrate mixture, from 17 to 20 weight percent of the concentrate mixture, from 18 to 20 weight percent of the concentrate mixture, and from 19 to 20 weight percent of the concentrate mixture. More examples of concentrations for the fatty acid alkyl ester, fatty acid amide, and/or triglyceride fatty acid ester incorporated into the aqueous herbicide concentrate mixture described herein include, from 0.2 to 19 weight percent of the concentrate mixture, from 0.3 to 18 weight percent of the concentrate mixture, from 0.4 to 17 weight percent of the concentrate mixture, from 0.5 to 16 weight percent of the concentrate mixture, from 0.6 to 15 weight percent of the concentrate mixture, from 0.7 to 14 weight percent of the concentrate mixture, from 0.8 to 13 weight percent of the concentrate mixture, from 0.9 to 12 weight percent of the concentrate mixture, from 1 to 11 weight percent of the concentrate mixture, from 2 to 10 weight percent of the concentrate mixture, from 2 to 9 weight percent of the concentrate mixture, from 2 to 8 weight percent of the concentrate mixture, from 2 to 7 weight percent of the concentrate mixture, from 2 to 6 weight percent of the concentrate mixture, from 2 to 5 weight percent of the concentrate mixture, from 2 to 4 weight percent of the concentrate mixture, and from 2 to 3 weight percent of the concentrate mixture.

The aqueous concentrate compositions can be stored in suitable containers as will be readily recognized by one of skill in the art and can be, for example, solutions, emulsions, or suspensions.

In an example of an aqueous concentrate composition, the herbicide is an auxinic herbicide and the auxinic herbicide is 2,4-D choline salt or 2,4-D dimethyl ammonium salt. In another example of an aqueous concentrate composition, the herbicide is an auxinic herbicide and the auxinic herbicide is 2,4-D choline salt or 2,4-D dimethyl ammonium salt, and the fatty acid alkyl ester, fatty acid amide, and/or triglyceride fatty acid ester is methyl caproate, methyl caprylate, methyl caprate, methyl laurate, methyl myristate, methyl palmitate, methyl stearate, methyl oleate, methyl linoleate, methyl linolenate, N,N-dimethylcaprylamide (N,N-dimethyloctanamide), N,N-dimethylcapramide (N,N-dimethyldecanamide), morpholine caprylamide, morpholine capramide, soybean oil, rapeseed oil, olive oil, castor oil, sunflower seed oil, almond oil, canola oil, omega-9 canola oil, coconut oil, corn oil, cotton seed oil, linseed oil, palm oil, peanut oil, safflower oil, sesame oil, tung oil, or mixtures thereof. In a further example of an aqueous concentrate composition, the herbicide is an auxinic herbicide and the auxinic herbicide is 2,4-D choline salt and the fatty acid alkyl ester, fatty acid amide, and/or triglyceride fatty acid ester is methyl caproate, methyl caprylate, methyl caprate, methyl laurate, methyl myristate, methyl palmitate, methyl stearate, methyl oleate, methyl linoleate, methyl linolenate, N,N-dimethylcaprylamide (N,N-dimethyloctanamide), N,N-dimethylcapramide (N,N-dimethyldecanamide), soybean oil, rapeseed oil, olive oil, castor oil, sunflower seed oil, almond oil, canola oil, omega-9 canola oil, coconut oil, corn oil, cotton seed oil, linseed oil, palm oil, peanut oil, safflower oil, sesame oil, tung oil, or mixtures thereof.

Aqueous spray solutions, containing 2,4-D and glyphosate are prone to incompatibility under certain conditions and concentrations leading to product performance issues and difficulty in using the products, i.e., difficulty with field applications of the products. Incompatibility in spray solutions may be minimized by the use of very small amounts of 2,4-D, such as less than about 3 wt % ae (acid equivalent) relative to the total composition and/or the use of compatibility additives such as is described in U.S. Application Ser. No. 61/523,958, which is incorporated herein by reference.

Optionally, the compositions described herein may additionally contain surfactants. The surfactants may be anionic, cationic, or nonionic in character. Examples of typical surfactants include alcohol-alkylene oxide addition products, such as tridecyl alcohol-C₁₆ ethoxylate; sorbitol esters, such as sorbitol oleate; quaternary amines, such as lauryl trimethylammonium chloride; ethoxylated amines, such as tallowamine ethoxylated; betaine surfactants, such as cocoamidopropyl betaine; fatty acid amidopropyl dimethylamine surfactants such as cocoamidopropyl dimethylamine; alkylpolyglycoside surfactants; poly-ethylene glycol esters of fatty acids, such as polyethylene glycol stearate; and fatty acid esters of polyglycerol.

The additional surfactant or mixtures of surfactants optionally used in the described compositions are usually present at a concentration of from about 0.5 to about 20 weight percent of the formulation. Additionally, compositions optionally containing one or more additional compatible ingredients are provided herein. These additional ingredients may include, for example, one or more pesticides or other ingredients, which may be dissolved or dispersed in the composition and may be selected from acaricides, bactericides, fungicides, insecticides, herbicides, herbicide safeners, insect attractants, insect repellents, plant activators, plant growth regulators, and synergists. Also, any other additional ingredients providing functional utility such as, for example, dyes, stabilizers, fragrants, viscosity-lowering additives, compatibility agents, organic co-solvents such as, for example, propylene glycol, propylene glycol ethers and/or ethylene glycol ethers, and freeze-point depressants may be included in these compositions. The use of organic co-solvents in the concentrates and spray solutions described herein may provide freezing-point depression and/or enhanced emulsion stability to these compositions.

The following Examples are presented to illustrate various aspects of the compositions and methods described herein and should not be construed as limitations to the claims.

### Example 1

### 2,4-D Choline Aqueous Concentrates with Built-in Fatty Acid Alkyl Esters

Aqueous herbicide concentrates containing 383 grams acid equivalent per kilogram (gae/kg) of 2,4-D choline, 40 g/kg of Ninate® 411 surfactant (Stepan; Northfield, Ill.), 2.5 g/kg of ethylenediaminetetraacetic acid choline salt (EDTA-choline; prepared by adding 1028.25 g of EDTA acid and 689.7 g of DI water into 2310.0 g of choline hydroxide solution (45 wt %) and stirring until all solids are dissolved), and 90 g/kg of one or more fatty acid alkyl esters (Table 1) were prepared as follows. A 4-oz vial was first charged with 9.00 g of a fatty acid ester. To the vial was added, 4.00 g of Ninate® 411, 86.00 g of a 44.5 wt % ae basis 2,4-D choline salt solution in water (prepared by dissolving 4171.0 g of 2,4-D acid flake (technical grade, 97.1 wt %) into 4789.4 g of choline hydroxide solution (45% aqueous solution) under low shear agitation to give a solution with a pH of 7.0 and a density of 1.21 g/mL) and finally 1.00 g of an EDTA-choline aqueous solution (25 wt %). The mixture was then homogenized using a Vibra-Cell™ ultrasonic processor (Sonics & Materials, Inc.; Newtown, Conn.) to provide 100 g of a homogenous herbicide concentrate.

TABLE 1
Fatty acid Esters Used to Prepare the
Aqueous Concentrates Described Herein

| Product | Chemical Name | Supplier |
|---|---|---|
| Steposol ® C-25 | methyl caprylate/caprate | Stepan^{a} |
| Steposol ® C-42 | methyl laurate/myristate | Stepan |
| NA | methyl palmitate | Aldrich^{b} |

^{a}Stepan; Northfield, IL.
^{b}Aldrich; St. Louis, MO.

Three aqueous concentrates containing the fatty acid esters shown in Table 1 and one aqueous concentrate containing only 2,4-D choline and EDTA-choline (control sample) were prepared in this manner.

### 2,4-D Choline Herbicide Spray Solutions and Spray Droplet Analysis

The three aqueous 2,4-D choline concentrates containing the fatty acid esters shown in Table 1 and the one aqueous concentrate containing only 2,4-D choline and EDTA-choline (control sample) were each tank-mixed with water alone (Spray solutions A in Table 2), with an aqueous solution of glyphosate potassium salt (Spray solutions B Table 2) and with an aqueous solution of glyphosate potassium salt containing 2 weight percent ammonium sulfate (Spray solutions C in Table 2). Spray solutions A containing 1.87% v/v 2,4-D choline were prepared by diluting 5.61 mL of each of the four 2,4-D choline concentrates with 294.39 mL of deionized water. Spray solutions B containing 1.87% v/v 2,4-D choline and 1.66% v/v glyphosate potassium were prepared by diluting 5.61 mL of each of the four 2,4-D choline concentrates with 4.99 mL of RoundUp PowerMax® (containing 540 gae/L of glyphosate potassium; Monsanto; St. Louis, Mo.) and 289.40 mL of deionized water. Spray solutions C containing 1.87% v/v 2,4-D choline and 1.66% v/v glyphosate potassium were prepared by diluting 5.61 mL of each of the four 2,4-D choline concentrates with 4.99 mL of RoundUp PowerMax® and 289.40 mL of a 2% ammonium sulfate (AMS) aqueous solution. All tank mixed spray solutions were lightly shaken by hand until each sample was homogenous. The nine herbicide spray solutions containing fatty acid esters and the three control samples without fatty acid esters were sprayed using a Teejet® 8002 flat fan nozzle (Teejet Technologies; Wheaton, Ill.) at 40 psi (276 kiloPascal) and the spray droplet size distribution measurement was made with a Sympatec Helos/KF high resolution laser diffraction particle sizer with an R7 lens (Sympatec GmbH; Clausthal-Zellerfeld, Germany). The tip of the nozzle was situated 12 inches (30.5 centimeters) above the path of the laser beam of the Sympatec particle sizer. The percentage of driftable fines was expressed as the volume percentage of spray droplets below 150 μm volume mean diameter (VMD) as shown in Table 2.

TABLE 2
Spray Droplet Analysis of 2,4-D Herbicide
Sprays Containing Fatty Acid Esters

| Fatty Acid Ester | Herbicide Spray Droplet Analysis | |
|---|---|---|
| Used¹ (9 wt % | Spray Droplet | Volume Percentage of |
| in concentrate) | VMD, μm | Driftable Fines <150 μm VMD |

Spray Solution A: 2,4-D choline

| | | |
|---|---|---|
| none (control) | 167 | 43% |
| Steposol ® C-25 | 152 | 48% |
| Steposol ® C-42 | 153 | 49% |
| methyl palmitate | 258 | 18% |

Spray Solutions B: 2,4-D choline + glyphosate K

| | | |
|---|---|---|
| none (control) | 150 | 49% |
| Steposol ® C-25 | 258 | 19% |
| Steposol ® C-42 | 254 | 20% |
| methyl palmitate | 236 | 22% |

Spray Solutions C: 2,4-D choline + glyphosate K + AMS

| | | |
|---|---|---|
| none (control) | 154 | 48% |
| Steposol ® C-25 | 240 | 23% |
| Steposol ® C-42 | 183 | 38% |
| methyl palmitate | 239 | 22% |

¹Steposol ® C-25 and Steposol ® C-42 are available from Stepan (Northfield, IL).

### Example 2

### 2,4-D Choline Aqueous Concentrates with Built-in Permaflo™ Biodiesel

Aqueous herbicide concentrates containing 383 gae/kg of 2,4-D choline, 40 g/kg of Ninate® 411 surfactant (Stepan; Northfield, Ill.), 40 g/kg of propylene glycol (co-solvent), 10 g/kg of ethylenediaminetetraacetic acid choline salt (EDTA-choline), 2.5 g/kg of polymeric surfactant Atlox™ 4912 (Croda; Edison, N.J.), 5.0 g/kg of surfactant Atplus™ 310 (Croda; Edison, N.J.) and 10-40 g/kg of Permaflo™ biodiesel (Indiana Soybean Alliance, Inc.; Indianapolis, Ind.) were prepared as described. A 4-oz vial was first charged with 1.00-4.00 g of Permaflo™ biodiesel. To the vial were added, 4.00 g of Ninate® 411, 0.25 g of Atlox™ 4912, 0.50 g of Atplus™ 310, 86.00 g of a 44.5 wt % ae basis 2,4-D choline salt solution in water, 4.00 g of an EDTA-choline aqueous solution (25 wt %) and then enough water to provide a total sample weight of 100 g. The mixture was then homogenized using a Vibra-Cell™ ultrasonic processor (Sonics & Materials, Inc.; Newtown, Conn.) to provide a homogenous herbicide concentrate. Three aqueous concentrates containing 1-4 wt % each of Permaflo™ biodiesel and one aqueous concentrate containing only 2,4-D choline and EDTA-choline (control sample) were prepared in this manner. In a similar manner, 2 additional samples, each containing 2 wt % Permaflo™ biodiesel were prepared: one without the Atplus™ 310 surfactant and the other substituting Duomeen® T (AkzoNobel; Chicago, Ill.) for the Atplus™ 310. All of the other ingredients and amounts in the two additional samples were the same as described herein for the other Permaflo™ biodiesel samples.

### 2,4-D Choline Herbicide Spray Solutions and Spray Droplet Analysis

The five aqueous 2,4-D choline concentrates containing Permaflo™ biodiesel and the one aqueous concentrate containing only 2,4-D choline and EDTA-choline (control sample) were each tank-mixed with water alone (Spray solutions A in Table 3), with an aqueous solution of glyphosate potassium salt (Spray solutions 13 in Table 3), and with an aqueous solution of glyphosate potassium salt containing 2 weight percent ammonium sulfate (Spray solutions C in Table 3). Spray solutions A containing 1.87% v/v 2,4-D choline were prepared by diluting 5.61 mL of each of the six 2,4-D choline concentrates with 294.39 mL, of deionized water. Spray solutions B containing 1.87% v/v 2,4-D choline and 1.66% v/v glyphosate potassium were prepared by diluting 5.61 mL of each of the six 2,4-D choline concentrates with 4.99 mL of RoundUp PowerMax® herbicide (containing 540 gae/L of glyphosate potassium; Monsanto; St. Louis, Mo.) and 289.40 mL of deionized water. Spray solutions C containing 1.87% v/v 2,4-D choline and 1.66% v/v glyphosate potassium were prepared by diluting 5.61 mL of each of the six 2,4-D choline concentrates with 4.99 mL of RoundUp PowerMax® herbicide and 289.40 mL of a 2% ammonium sulfate (AMS) aqueous solution. All tank mixed spray solutions were lightly shaken by hand until each sample was homogeneous. The 15 herbicide spray solutions containing Permaflo™ biodiesel and the three control samples without Permaflo™ biodiesel were sprayed as described in Example 1. The percentage of drillable fines was expressed as the volume percentage of spray droplets below 150 μm volume mean diameter (VMD) as shown in Table 3.

TABLE 3
Spray Droplet Analysis of 2,4-D Herbicide
Sprays Containing Fatty Acid Esters

| Amount of | Herbicide Spray Droplet Analysis | |
|---|---|---|
| Permaflo ™ | | Volume Percentage |
| Biodiesel¹ | Spray Droplet | of Driftable |
| in Concentrate | VMD, μm | Fines <150 μm VMD |

Spray Solutions A: 2.4-D choline

| | | |
|---|---|---|
| none (control) | 167 | 43% |
| 4 wt % | 270 | 16% |
| 2 wt % | 264 | 18% |
| 1 wt % | 248 | 21% |
| 2 wt % (no Atplus 310)² | 275 | 14% |
| 2 wt % (Duomeen T in | 225 | 27% |
| place of Atplus 310)² | | |

Spray Solutions B: 2,4-D choline + glyphosate K

| | | |
|---|---|---|
| none (control) | 150 | 49% |
| 4 wt % | 252 | 19% |
| 2 wt % | 216 | 29% |
| 1 wt % | 178 | 40% |
| 2 wt % (no Atplus 310)² | 214 | 29% |
| 2 wt % (Duomeen T in | 229 | 26% |
| place of Atplus 310)² | | |

Spray Solutions C: 2,4-D choline + glyphosate K + AMS

| | | |
|---|---|---|
| none (control) | 154 | 48% |
| 4 wt % | 220 | 28% |
| 2 wt % | 255 | 20% |
| 1 wt % | 243 | 23% |
| 2 wt % (no Atplus 310)² | 257 | 17% |
| 2 wt % (Duomeen T in | 254 | 20% |
| place of Atplus 310)² | | |

¹Permaflo ™ biodiesel is available from the Indiana Soybean Alliance, Inc. (Indianapolis, IN);
²Atp1us ™ 310 and Duomeen ® T are available from Croda (Edison, NJ) and AkzoNobel (Chicago, IL), respectively.

### Example 3

### 2,4-D Choline Aqueous Concentrates with Built-in Rapeseed Oil

Aqueous herbicide concentrates containing 383 gae/kg of 2,4-D choline, 35 g/kg of propylene glycol (co-solvent), 5 g/kg of ethylenediaminetetraacetic acid choline salt (EDTA-choline), 2.5 g/kg of polymeric surfactants Atlox™ 4912 (Croda; Edison, N.J.) and 2.5 g/kg of Tergitol™ XD (Dow Chemical; Midland, Mich.), 5.0 g/kg of surfactant Atplus™ 310 (Croda; Edison, N.J.), and 40 g/kg of rapeseed oil (MP Biomedicals LLC; Solon, Ohio) were prepared as described. A 4-oz vial was first charged with 4.00 g of rapeseed oil. To the vial were added, 0.25 g of Tergitol™ XD, 0.25 g of Atlox™ 4912, 0.50 g of Atplus™ 310, 86.00 g of a 44.5 wt % (ae basis) of a 2,4-D choline salt solution in water, 2.00 g of an EDTA-choline aqueous solution (25 wt %) and then enough water to provide a total sample weight of 100 g. The mixture was then homogenized using a Vibra-Cell™ ultrasonic processor (Sonics & Materials, Inc.; Newtown, Conn.) to provide a homogenous herbicide concentrate. One aqueous concentrate containing 4 wt % rapeseed oil and one aqueous concentrate containing only 2,4-D choline and EDTA-choline (control sample) were prepared in this manner.

### 2,4-D Choline Herbicide Spray Solutions and Spray Droplet Analysis

The aqueous 2,4-D choline concentrate containing rapeseed oil and the aqueous concentrate containing only 2,4-D choline and EDTA-choline (control sample) were each tank-mixed with water alone (Spray solutions A in Table 4), with an aqueous solution of glyphosate potassium salt (Spray solutions B in Table 4), and with an aqueous solution of glyphosate DMA salt (Spray solutions C in Table 4). Spray solutions A containing 1.87% v/v 2,4-D choline were prepared by diluting 5.61 mL of each of 2,4-D choline concentrate with 294.39 mL of deionized water. Spray solutions B containing 1.87% v/v 2,4-D choline and 1.66% v/v glyphosate potassium were prepared by diluting 5.61 mL of each 2,4-D choline concentrate with 4.99 mL of RoundUp PowerMax® herbicide (containing 540 gae/L of glyphosate potassium; Monsanto; St. Louis, Mo.) and 289.40 mL of deionized water. Spray solutions C containing 1.87% v/v 2,4-D choline and 1.87% v/v glyphosate DMA were prepared by diluting 5.61 mL of each 2,4-D choline concentrate with 5.61 mL of Durango® DMA® herbicide (containing 480 gae/L of glyphosate dimethylamine salt; Dow AgroSciences; Indianapolis, Ind.) and 288.78 mL of deionized water. All tank mixed spray solutions were lightly shaken by hand until each sample was homogenous. The 3 herbicide spray solutions containing rapeseed oil and the three control samples without rapeseed oil were sprayed as described in Example 1. The percentage of driftable fines was expressed as the volume percentage of spray droplets below 150 μm volume mean diameter (VMD) as shown in Table 4.

TABLE 4
Spray Droplet Analysis of 2,4-D Herbicide
Sprays Containing Rapeseed Oil

| | Herbicide Spray Droplet Analysis | |
|---|---|---|
| Amount of Rapeseed | Spray Droplet | Volume Percentage of |
| Oil in Concentrate | VMD, μm | Driftable Fines <150 μm VMD |

Spray Solutions A: 2.4-D choline

| | | |
|---|---|---|
| none (control) | 167 | 43% |
| 4 wt % | 261 | 19% |

Spray Solutions B: 2,4-D choline + glyphosate K

| | | |
|---|---|---|
| none (control) | 150 | 49% |
| 4 wt % | 205 | 31% |

Spray Solutions C: 2,4-D choline + glyphosate DMA

| | | |
|---|---|---|
| none (control) | 160 | 46% |
| 4 wt % | 225 | 26% |

### Example 4

### 2,4-D Choline Aqueous Concentrates Containing Built-in Fatty Acid Alkyl Esters

Aqueous herbicide concentrates containing 383 gae/kg of 2,4-D choline. 40 g/kg of Ninate® 411 surfactant (available from Stepan; Northfield, Ill.), 2.5 g/kg of ethylenediaminetetraacetic acid choline salt, 2.5 g/kg of polymeric surfactant Atlox™ 4912 (Croda, Edison, N.J.) and 5.0 g/kg of surfactant Atplus™ 310 (Croda, Edison, N.J.), and 20-40 g/kg of two or more fatty acid alkyl esters (selected from Steposol® C-42, methyl palmitate and Agnique® ME 181-U (methyl oleate; BASF-Cognis; Cincinnati, Ohio)) were prepared as described. A 4-oz vial was first charged with 2.00-4.00 g of the fatty acid esters. To the vial was added 4.00 g of Ninate® 411, 0.25 g of Atlox™ 4912, 0.50 g of Atplus™ 310, 86.00 g of a 44.5 wt % ae basis 2,4-D choline salt solution in water, 1.00 g of an EDTA-choline aqueous solution (25 wt %) and then enough water to make 100 grams of the concentrate. The mixture was then homogenized using a Vibra-Cell™ ultrasonic processor (Sonics & Materials, Inc.; Newtown, Conn.) to provide a homogenous herbicide concentrate. Seven samples containing the fatty acid esters and one concentrate containing only 2,4-D and EDTA-choline (control sample) were prepared in this manner.

### 2,4-D Choline Herbicide Spray Solutions and Spray Droplet Analysis

The 7 aqueous 2,4-D choline concentrates containing the fatty acid esters and the aqueous concentrate containing only 2,4-D choline and EDTA-choline (control sample) were tank-mixed with water alone (Spray solutions A in Table 5), with an aqueous solution of glyphosate potassium salt (Spray solutions B in Table 5), and with an aqueous solution of glyphosate K salt (Spray solutions C in Table 5) containing 2 wt % ammonium sulfate (AMS). Spray solutions A containing 1.87% v/v 2,4-D choline were prepared by diluting 5.61 mL of each of the eight 2,4-D choline concentrates with 294.39 mL of deionized water. Spray solutions B containing 1.87% v/v 2,4-D choline and 1.66% v/v glyphosate potassium were prepared by diluting 5.61 mL of each of the eight 2,4-D choline concentrates with 4.99 mL of RoundUp PowerMax® herbicide (containing 540 gae/L of glyphosate potassium; Monsanto; St. Louis, Mo.) and 289.40 mL of deionized water. Spray solutions C containing 1.87% v/v 2,4-D choline and 1.66% v/v glyphosate potassium were prepared by diluting 5.61 mL of each of the eight 2,4-D choline concentrates with 4.99 mL of RoundUp PowerMax® herbicide and 289.4 mL of 2% aqueous ammonium sulfate. All tank mixed spray solutions were lightly shaken by hand until each sample was homogenous. The 21 herbicide spray solutions containing the fatty acid esters shown in Table 5 and the three control samples without the fatty acid esters were sprayed as described in Example 1. The percentage of driftable fines was expressed as the volume percentage of spray droplets below 150 μm volume mean diameter (VMD) as shown in Table 5.

TABLE 5
Spray Droplet Analysis of 2,4-D Herbicide
Sprays Containing Fatty Acid Esters

| | | | Spray Solutions B | | Spray Solutions C | |
|---|---|---|---|---|---|---|
| | Spray Solutions A | | (2,4-D + Glyphosate | | (2,4-D + Glyphosate | |
| | (2,4-D in water) | | K in water) | | K in 2% AMS) | |
| | Spray | Vol. % of | | Vol. % of | | Vol. % of |
| Amount of Fatty Acid | Droplet | Driftable Fines | Spray Droplet | Driftable Fines | Spray Droplet | Driftable Fines |
| Esters in Concentrate¹ | VMD, μm | <150 μm VMD | VMD, μm | <150 μm VMD | VMD, μm | <150 μm VMD |
| None (control) | 167 | 43% | 150 | 49% | 154 | 48% |
| Methyl palmitate (2 wt %) + | 268 | 17% | 239 | 23% | 229 | 25% |
| Steposol ® C-42 (2 wt %) | | | | | | |
| Methyl palmitate (2 wt %) + | 270 | 16% | 248 | 20% | 242 | 22% |
| Agnique ® ME 181-U (2 wt %) | | | | | | |
| Steposol ® C42 (2 wt %) + | 269 | 16% | 244 | 21% | 195 | 35% |
| Agnique ® ME 181-U (2 wt %) | | | | | | |
| Methyl palmitate (1 wt %) + | 233 | 24% | 167 | 43% | 224 | 26% |
| Steposol ® C-42 (1 wt %) | | | | | | |
| Steposol ® C42 (2 wt %) + | 264 | 17% | 256 | 18% | 217 | 28% |
| Agnique ® ME 181-U (1 wt %) | | | | | | |
| Steposol ® C42 (1 wt %) + | 278 | 13% | 258 | 18% | 224 | 26% |
| Agnique ® ME 181-U (2 wt %) | | | | | | |
| Steposol ® C42 (1 wt %) + | 250 | 20% | 230 | 24% | 224 | 26% |
| Agnique ® ME 181-U (1 wt %) | | | | | | |

¹Agnique ® ME 181-U is available from BASF-Cognis (Cincinnati, OH); Steposol ® C-42 is available from Stepan (Northfield, IL).

### Example 5

### Chorine Aqueous Concentrates Containing Built-in Fatty Acid Alkyl Esters

Aqueous herbicide concentrates containing 383 gae/kg of 2,4-D choline, 40 g/kg of Ninate® 411 surfactant (Stepan; Northfield, Ill.), 2.5 g/kg of ethylenediaminetetraacetic acid choline salt, 2.5 g/kg of polymeric surfactant Atlox™ 4912 (Croda, Edison. NJ) and 40 or 92.5 g/kg of fatty acid alkyl esters (Agnique® 1218-U; mixture of C₁₂-C₁₈ fatty acid methyl esters; BASF-Cognis; Cincinnati, Ohio) were prepared as described. A 4-oz vial was first charged with 4.00 g or 9.25 g of Agnique® 1218-U. To the vial 4.00 g of Ninate® 411 and 0.25 g of Atlox® 4912 were added. Then, 86.00 g of a 44.5 wt % ae 2,4-D choline salt solution in water and 0.25 g of EDTA-choline solution (25 wt %) were added to the vial. Lastly, deionized water was added to provide 100 g of each herbicide concentrate. The mixtures were then homogenized using ultrasonic processor (Sonics, Vibra-Cell). Two samples containing the fatty acid esters and one concentrate containing only 2,4-D and EDTA-choline (control sample) were prepared in this manner.

### 2,4-D Choline Herbicide Spray Solutions and Spray Droplet Analysis

The 2 aqueous 2,4-D choline concentrates containing the fatty acid esters and the aqueous concentrate containing only 2,4-D choline and EDTA-choline (control sample) were tank-mixed with water alone (Spray solutions A in Table 6), with an aqueous solution of glyphosate potassium salt (Spray solutions B in Table 6), and with an aqueous solution of glyphosate K salt (Spray solutions C in Table 6) containing 2 wt % ammonium sulfate (AMS). Spray solutions A containing 1.87% v/v 2,4-D choline were prepared by diluting 5.61 mL of each 2,4-D choline concentrate with 294.39 mL of deionized water. Spray solutions B containing 1.87% v/v 2,4-D choline and 1.66% v/v glyphosate potassium were prepared by diluting 5.61 mL of each 2,4-D choline concentrate with 4.99 mL of RoundUp PowerMax® herbicide (containing 540 gae/L of glyphosate potassium; Monsanto; St. Louis, Mo.) and 289.40 mL of deionized water. Spray solutions C containing 1.87% v/v 2,4-D choline and 1.66% v/v glyphosate potassium were prepared by diluting 5.61 mL of each 2,4-D choline concentrates with 4.99 mL of RoundUp PowerMax® herbicide and 289.4 mL of 2% aqueous ammonium sulfate. All tank mixed spray solutions were lightly shaken by hand until each sample was homogenous. The 6 herbicide spray solutions containing the fatty acid esters shown in Table 6 and the three control samples without the fatty acid esters were sprayed as described in Example 1. The percentage of drillable fines was expressed as the volume percentage of spray droplets below 150 μm volume mean diameter (VMD) as shown in Table 6.

TABLE 6
Spray Droplet Analysis of 2,4-D Herbicide
Sprays Containing Fatty Acid Esters

| | |
|---|---|
| Amount of | Herbicide Spray Droplet Analysis |

| | | |
|---|---|---|
| Agnique ® | | Volume Percentage |
| 1218-U in | Spray Droplet | of Driftable |
| Concentrate¹ | VMD, μm | Fines <150 μm VMD |

Spray Solutions A: 2,4-D choline

| | | |
|---|---|---|
| none (control) | 167 | 43% |
| 4 wt % | 254 | 19% |
| 9.25 wt % | 266 | 17% |

Spray Solutions B: 2,4-D choline + glyphosate K

| | | |
|---|---|---|
| none (control) | 150 | 49% |
| 4 wt % | 226 | 26% |
| 9.25 wt % | 259 | 18% |

Spray Solutions C: 2,4-D choline +
glyphosate K + 2% AMS

| | | |
|---|---|---|
| none (control) | 154 | 48% |
| 4 wt % | 162 | 45% |
| 9.25 wt % | 241 | 23% |

¹Agnique ® 1218-U is available from BASF-Cognis (Cincinnati, OH)

### Example 6

### 2,4-D Choline Aqueous Concentrates Containing Built-in Fatty Acid Amides

To 9.0 g of an aqueous 2,4-D choline salt concentrate, (538 gae/L) was added 1.0 g of Agnique® AMD 810 (BASF-Cognis; Cincinnati, Ohio). After brief agitation a clear homogeneous concentrate resulted. A 400 g quantity of spray solution was prepared by adding the concentrate (2.2% of the total weight of spray solution) to deionized water to form a hazy blue emulsion. The hazy blue emulsion and a control sample containing only 2,4-D choline salt were sprayed as described in Example 1. The percentage of drillable fines was expressed as the volume percentage of spray droplets below 150 μm volume mean diameter (VMD) as shown in Table 7.

TABLE 7
Spray Droplet Analysis of 2,4-D Herbicide
Sprays Containing Fatty Acid Dialkylamides

| Auxinic Herbicide/Fatty Acid | Volume Percent Driftable |
|---|---|
| Dialkylamide | Fines <150 μm VMD |
| 2,4-D choline/Agnique ® AMD 810¹ | 39 |
| 2,4-D choline (control) | 45 |

¹Agnique ® AMD 810 is available from BASF-Cognis (Cincinnati, OH)

### Example 7

### 2,4-D Choline Aqueous Concentrates with Built-in Canola Oil

Aqueous herbicide concentrates containing 383 gae/kg of 2,4-D choline, 35 g/kg of propylene glycol (co-solvent), 12.5 g/kg of ethylenediaminetetraacetic acid choline salt (EDTA-choline), 2.5 g/kg of polymeric surfactants Atlox™ 4912 (Croda; Edison, N.J.) and 2.5 g/kg of Atlas G-5000 (Croda; Edison, N.J.), 10 g/kg of Ninate® 411 surfactant (available from Stepan; Northfield, Ill.), and 40 g/kg of canola oil (Dow AgroSciences LLC; Indianapolis, Ind.) were prepared as described. A 4-oz vial was first charged with 4.00 g of canola oil. To the vial were added, 0.25 g of Atlas F-5000, 0.25 g of Atlox™ 4912, 1.00 g of Ninate® 411, 86.00 g of a 44.5 wt % (ae basis) of a 2,4-D choline salt solution in water, 3.50 g of propylene glycol, and 5.00 g of an EDTA-choline aqueous solution (25 wt %) to provide a total sample weight of 100 g. The mixture was then homogenized using a Vibra-Cell™ ultrasonic processor (Sonics & Materials, Inc.; Newtown, Conn.) to provide a homogenous herbicide concentrate. One aqueous concentrate containing 4 wt % canola oil and one aqueous concentrate containing only 2,4-D choline and EDTA-choline (control sample) were prepared in this manner.

### 2, 4-D Choline Herbicide Spray Solutions and Spray Droplet Analysis

The aqueous 2,4-D choline concentrate containing canola oil and the aqueous concentrate containing only 2,4-D choline and EDTA-choline (control sample) were each tank-mixed with water alone (Spray solutions A in Table 8), with an aqueous solution of glyphosate potassium salt (Spray solutions B in Table 8), and with an aqueous solution of glyphosate DMA salt (Spray solutions C in Table 8). Spray solutions A containing 1.87% v/v 2,4-D choline were prepared by diluting 5.61 mL of each 2,4-D choline concentrate with 294.39 ml of deionized water. Spray solutions B containing 1.87 v/v 2, 4-D choline and 1.66% v/v glyphosate potassium were prepared by diluting 5.61 mL of each 2,4-D choline concentrate with 4.99 mL of RoundUp PowerMax® herbicide (containing 540 gae/L of glyphosate potassium; Monsanto; St. Louis, Mo.) and 289.40 mL of deionized water. Spray solutions C containing 1.87% v/v 2,4-D choline and 1.87% v/v glyphosate DMA were prepared by diluting 5.61 mL of each 2,4-D choline concentrate with 5.61 mL of Durango® DMA® herbicide (containing 480 gae/L of glyphosate dimethylamine salt; Dow AgroSciences; Indianapolis, Ind.) and 288.78 mL of deionized water. All tank mixed spray solutions were lightly shaken by hand until each sample was homogenous. The 3 herbicide spray solutions containing canola oil and the three control samples without canola oil were sprayed as described in Example 1. The percentage of driftable fines was expressed as the volume percentage of spray droplets below 150 μm volume mean diameter (VMD) as shown in Table 8.

TABLE 8
Spray Droplet Analysis of 2,4-D Herbicide
Sprays Containing Canola Oil

| | Herbicide Spray Droplet Analysis | |
|---|---|---|
| Amount of Canola Oil | Spray Droplet | Volume Percentage of |
| in Concentrate | VMD, μm | Driftable Fines <150 μm VMD |

Spray Solutions A: 2,4-D choline

| | | |
|---|---|---|
| none (control) | 161 | 45% |
| 4 wt % | 271 | 19% |

Spray Solutions B; 2,4-D choline + glyphosate K

| | | |
|---|---|---|
| none (control) | 150 | 49% |
| 4 wt % | 211 | 30% |

Spray Solutions C: 2,4-D choline + glyphosate DMA

| | | |
|---|---|---|
| none (control) | 160 | 46% |
| 4 wt % | 224 | 27% |

### Example 8

### 2,4-D Choline Herbicide Concentrates Containing Built-in Vegetable Oils

Aqueous herbicide concentrates containing 383 gae/kg of 2,4-D choline, 40 g/kg of Atlox DP 13/6 surfactant (Croda; Edison, N.J.), 20 g/kg of propylene glycol (co-solvent), 9.625 g/kg of ethylenediaminetetraacetic acid choline salt (EDTA-choline; prepared by adding 1028.25 g of EDTA acid and 689.7 g of DI water into 2310.0 g of choline hydroxide solution (45 wt %) and stirring until all solids are dissolved), 2.5 g/kg of polymeric surfactant Atlox™ 4912 (Croda; Edison, N.J.), 19 g/kg of choline hydroxide (Aldrich) and 20 g/kg of plant oil were prepared as described. A 4-oz vial (Vial A) was first charged with 2 g of a plant oil. To Vial A were then added, 4.00 g of Atlox DP 13/6, 0.25 g of Atlox™ 4912, and 2.00 g of propylene glycol, the mixture formed was stirred with an overhead mixer until a homogenous solution was formed. To a second 4-oz (Vial B) were added 86.00 g of a 44.5 wt % ae basis 2,4-D choline salt solution in water, 3.85 g of an EDTA-choline aqueous solution (25 wt %), 1.90 g of choline hydroxide (45 wt % in water), and the ingredients of Vial A to provide a total sample weight of 100 g. The resulting mixture in Vial B was then mixed with overhead agitator to provide a homogenous herbicide concentrate with built-in plant oil. Five aqueous herbicide concentrates containing omega-9 canola oil, canola oil, soybean oil, safflower oil or almond oil and one aqueous control concentrate where the 2 wt % of plant oil was substituted with water were prepared in this manner.

TABLE 9
Composition of 2,4-D Choline Herbicide Concentrates
Containing Built-in Plant Oil

| Component | wt % |
|---|---|
| 2,4-D Choline Solution | 86.00% |
| Propylene glycol | 2.00% |
| Atlox DP13/6 | 4.00% |
| EDTA-choline (25 wt %) | 3.85% |
| Plant oil | 2.00% |
| Atlox 4912 | 0.25% |
| Choline OH (45 wt %) | 1.90% |
| Total | 100.00% |

### 2,4-D Choline Herbicide Spray Solutions and Spray Droplet Analysis

The five aqueous 2,4-D choline concentrates containing plant oil and the one aqueous control sample were each tank-mixed with water alone (Spray solutions A in Table 10), with an aqueous solution of glyphosate potassium salt (Spray solutions B in Table 10), and with an aqueous solution of glyphosate dimethylamine (DMA) (Spray solutions C in Table 10). Spray solutions A containing 1.87% v/v of 2,4-D choline concentrate were prepared by diluting 5.61 mL of each of the six 2,4-D choline concentrates with 294.39 mL of deionized water. Spray solutions B containing 1.87% v/v of 2,4-D choline concentrate and 2.78% v/v of glyphosate potassium concentrate were prepared by diluting 5.61 mL of each of the six 2,4-D choline concentrates with 8.34 mL of Roundup PowerMax® herbicide (containing 540 gae/L of glyphosate potassium; Monsanto; St. Louis, Mo.) and 286.05 mL of deionized water. Spray solutions C containing 1.87% v/v of 2,4-D choline concentrate and 3.125% v/v of glyphosate DMA concentrate were prepared by diluting 5.61 mL of each of the six 2,4-D choline concentrates with 9.375 mL of Durango® herbicide (containing 480 gae/L glyphosate DMA, Dow AgroSciences, Indianapolis, Ind.) and 285.015 mL of deionized water. All tank mixed spray solutions were lightly shaken by hand until each sample was homogenous. The 15 herbicide spray solutions containing vegetable oils and the three control samples without plant oils were sprayed as described in Example 1. The percentage of driftable fines was expressed as the volume percentage of spray droplets below 150 μm volume mean diameter (VMD) as shown in Table 10.

TABLE 10
Spray Droplet Analysis of 2,4-D Herbicide
Sprays Containing Vegetable Oils

| Plant oil | Herbicide Spray Droplet Analysis | |
|---|---|---|
| Used¹ (2 wt % | Spray Droplet | Volume Percentage of |
| in concentrate) | VMD, μm | Driftable Fines <150 μm VMD |

Spray Solutions A: 2,4-D choline

| | | |
|---|---|---|
| none (control) | 160 | 45 |
| Omega-9 Canola oil | 272 | 15 |
| Canola oil | 263 | 17 |
| Soybean oil | 265 | 17 |
| Safflower oil | 272 | 15 |
| Almond oil | 273 | 16 |

Spray Solutions B: 2,4-D choline + glyphosate K

| | | |
|---|---|---|
| none (control) | 144 | 52 |
| Omega-9 Canola oil | 236 | 21 |
| Canola oil | 224 | 25 |
| Soybean oil | 206 | 30 |
| Safflower oil | 231 | 23 |
| Almond oil | 229 | 23 |

Spray Solutions C: 2,4-D choline + glyphosate DMA

| | | |
|---|---|---|
| none (control) | 148 | 50 |
| Omega-9 Canola oil | 241 | 19 |
| Canola oil | 241 | 20 |
| Soybean oil | 229 | 24 |
| Safflower oil | 245 | 19 |
| Almond oil | 245 | 20 |

### Example 9

### 2,4-D Choline Herbicide Concentrates with Varied Loadings of Omega-9 Canola Oil

Aqueous herbicide concentrates containing 383 gae/kg of 2,4-D choline, 40 g/kg of Atlox DP 13/6 surfactant (Croda; Edison, N.J.), 20 g/kg of propylene glycol (co-solvent), 2.5 g/kg of polymeric surfactant Atlox™ 4912 (Croda; Edison, N.J.), 19 g/kg of choline hydroxide (Aldrich) and 10-20 g/kg of omega-9 canola oil (Dow AgroSciences, Indianapolis, Ind.) were prepared as described. A 4-oz vial (Vial A) was first charged with 1, 1.5 or 2 g of omega-9 canola oil. To the vial were added, 4.00 g of Atlox DP 13/6, 0.25 g of Atlox™ 4912, 2.00 g of propylene glycol, the mixture was stirred with overhead mixer until a homogenous solution forms. To a second 4-oz vial (Vial B) were added 86.00 g of a 44.5 wt % ae basis 2,4-D choline salt solution in water, 3.85 to 4.85 g of an EDTA-choline aqueous solution (25 wt %), 1.90 g of choline hydroxide (45 wt %), and the ingredient of (Vial A) to provide a total sample weight of 100 g. The resulting mixture was then mixed with an overhead agitator to provide a homogenous herbicide concentrate with built-in omega-9 canola oil (Table 11).

TABLE 11
Composition of 2,4-D Choline Herbicide Concentrates
with Varied Loadings of Omega-9 Canola Oil

| Component | wt % |
|---|---|
| 2,4-D Choline Solution | 86.00% |
| Propylene glycol | 2.00% |
| Atlox DP13/6 | 4.00% |
| EDTA-choline (25 wt %) | 3.85-4.85% |
| Omega-9 canola oil | 1-2% |
| Atlox 4912 | 0.25% |
| Choline OH (45 wt %) | 1.90% |
| Total | 100.00% |

Three aqueous concentrates containing 2 wt %, 1.5 wt %, and 1 wt % of omega-9 canola oil and one aqueous control concentrate where the omega-9 canola oil was substituted with water were prepared in this manner.

### 2, 4-D Choline Herbicide Spray Solutions and Spray Droplet Analysis

The three aqueous 2,4-D choline concentrates containing omega-9 canola oil and one aqueous control sample were each tank-mixed with water alone (Spray solutions A in Table 12), with an aqueous solution of glyphosate potassium salt (Spray solutions B in Table 12), and with an aqueous solution of glyphosate dimethylamine (DMA) (Spray solutions C in Table 12). Spray solutions A containing 1.87% v/v of 2,4-D choline concentrate were prepared by diluting 5.61 mL of each of the four 2,4-D choline concentrates with 294.39 mL of deionized water. Spray solutions B containing 1.87% v/v of 2,4-D choline concentrate and 2.78%/v/v of glyphosate potassium concentrate were prepared by diluting 5.61 mL of each of the four 2,4-D choline concentrates with 8.34 mL of RoundUp PowerMax® herbicide (containing 540 gae/L of glyphosate potassium; Monsanto; St. Louis, Mo.) and 286.05 mL of deionized water. Spray solutions C containing 1.87% v/v of 2,4-D choline concentrate and 3.125% v/v of glyphosate DMA concentrate were prepared by diluting 5.61 mL of each of the four 2,4-D choline concentrates with 9.375 mL of Durango® herbicide (containing 480 glyphosate DMA, Dow AgroSciences, Indianapolis, Ind.) and 285.015 mL of deionized water. All tank mixed spray solutions were lightly shaken by hand until each sample was homogenous. The 9 herbicide spray solutions containing varied loadings of the omega-9 canola oil and the three control samples without omega-9 canola oil were sprayed using the method described in Example 1. The percentage of driftable fines was expressed as the volume percentage of spray droplets below 150 μm volume mean diameter (VMD) as shown in Table 12.

TABLE 12
Spray Droplet Analysis of 2,4-D Herbicide
Sprays Containing Omega-9 Canola Oil

| Concentration of | | |
|---|---|---|
| Omega-9 Canola | Herbicide Spray Droplet Analysis | |
| Oil in 2,4-D | Spray Droplet | Volume Percentage of |
| Concentrate | VMD, μm | Driftable Fines <150 μmVMD |

Spray Solutions A: 2,4-D choline

| | | |
|---|---|---|
| none (control) | 160 | 45 |
| 2 wt % | 272 | 15 |
| 1.5 wt % | 265 | 18 |
| 1 wt % | 245 | 30 |

Spray Solutions B: 2,4-D choline + glyphosate K

| | | |
|---|---|---|
| none (control) | 144 | 52 |
| 2 wt % | 236 | 21 |
| 1.5 wt % | 234 | 22 |
| 1 wt % | 178 | 36 |

Spray Solutions C: 2,4-D choline + glyphosate DMA

| | | |
|---|---|---|
| none (control) | 148 | 50 |
| 2 wt % | 241 | 19 |
| 1.5 wt % | 248 | 20 |
| 1 wt % | 213 | 33 |

### Example 10

### 2,4-D Choline Herbicide Concentrates with Omega-9 Canola Oil and Varied Phosphate Ester Surfactants

Aqueous herbicide concentrates containing 383 gae/kg of 2,4-D choline, 40 g/kg of a phosphate ester surfactant (Croda; Edison, N.J.), 20 g/kg of propylene glycol (co-solvent), 2.5 g/kg of polymeric surfactant Atlox™ 4912 (Croda; Edison, N.J.), from 0 g/kg to 37.5 g/kg of choline hydroxide (45 wt % solution, Aldrich), 20 g/kg of omega-9 canola oil (Dow AgroSciences, Indianapolis, Ind.), and from 5 g/kg, to 14.375 g/kg of EDTA choline salt were prepared as described. A 4-oz vial (Vial A) was first charged with 2 g of omega-9 canola oil. To the vial were added, 4.00 g of a phosphate ester surfactant (Table 14), 0.25 g of Atlox™ 4912, and 2.00 g of propylene glycol, and the mixture was stirred with overhead mixer until a homogenous solution formed. To a second 4-oz vial (Vial B) were added 86.00 g of a 44.5 wt % ae basis 2,4-D choline salt solution in water and the ingredients in Vial A. The resulting mixture was then mixed with an overhead agitator and from 0 g to 3.75 g of choline hydroxide (45 wt % solution) was added to the mixture until the pH of the mixture was 7. The remaining 2 g to 5.75 g of EDTA choline (25 wt % solution) was then added to provide a total sample weight of 100 g.

TABLE 13
Composition of 2,4-D Choline Herbicide Concentrates
with Varied Loadings of Omega-9 Canola Oil

| Components | Wt % |
|---|---|
| 2,4-D Choline Solution | 86.00% |
| Propylene glycol | 2.00% |
| Phosphate ester surfactant | 4.00% |
| EDTA-choline (25 wt %) | 2-5.75% |
| Omega-9 canola oil | 2% |
| Atlox 4912 | 0.25% |
| Choline OH (45 wt %) | 0-3.75% |
| Total | 100.00% |

Twelve aqueous herbicide concentrates containing omega-9 canola oil and a phosphate ester surfactant (from those listed in Table 14), and one aqueous control concentrate where the omega-9 canola oil was substituted with water and containing no phosphate ester surfactant were prepared in this manner.

### 2,4-D Choline Herbicide Spray Solutions and Spray Droplet Analysis

The twelve aqueous 2,4-D choline concentrates containing a phosphate ester surfactant and the one aqueous control sample were each tank-mixed with water alone (Spray solutions A in Table 14), with an aqueous solution of glyphosate potassium salt (Spray solutions 13 in Table 14), and with an aqueous solution of glyphosate dimethylamine (DMA) (Spray solutions C in Table 14). Spray solutions A containing 1.87 v/v of 2,4-D choline concentrate were prepared by diluting 5.61 mL of each of the 13 2,4-D choline concentrates with 294.39 mL of deionized water. Spray solutions B containing 1.87% v/v of 2,4-D choline concentrate and 2.78% v/v of glyphosate potassium concentrate were prepared by diluting 5.61 mL of each of the 13 2,4-D choline concentrates with 8.34 mL of RoundUp PowerMax® herbicide (containing 540 gae/L of glyphosate potassium; Monsanto; St. Louis, Mo.) and 286.05 mL of deionized water. Spray solutions C containing 1.87% v/v of 2,4-D choline concentrate and 3.125% v/v of glyphosate DMA concentrate were prepared by diluting 5.61 mL of each of the 13 2,4-D choline concentrates with 9.375 mL of Durango® herbicide (containing 480 gae/L glyphosate DMA, Dow AgroSciences, Indianapolis, Ind.) and 285.015 mL deionized water. All tank mixed spray solutions were lightly shaken by hand until each sample was homogenous. The 36 herbicide spray solutions containing the phosphate ester surfactants and the three control samples without omega-9 canola oil were sprayed using the method described in Example 1. The percentage of driftable fines was expressed as the volume percentage of spray droplets below 150 μm volume mean diameter (VMD) as shown in Table 14.

TABLE 14
Spray Droplet Analysis of 2,4-D Herbicide Sprays Containing
Omega-9 Canola Oil and Various Phosphate Ester Surfactants

| | Spray Solutions A | Spray Solutions B | Spray Solutions C |
|---|---|---|---|
| Phosphate ester | (2,4-D choline) | (2,4-D + glyphosate K) | (2,4-D + glyphosate DMA) |
| surfactants¹ | Volume Percentage of | Volume Percentage of | Volume Percentage of |
| (4 wt % in | Driftable Fines | Driftable Fines | Driftable Fines |
| concentrate) | (<150 μm VMD) | (<150 μm VMD) | (<150 μm VMD) |
| control² | 45 | 52 | 50 |
| Atplus 310 | 18 | 23 | 19 |
| Atlox AL-3382 | 19 | 28 | 20 |
| Atlox DP13/6 | 15 | 21 | 19 |
| Crodafos O3A | 14 | 24 | 19 |
| Crodafos T6A | 17 | 22 | 19 |
| Multitrope 1214 | 18 | 27 | 23 |
| Crodafos C10/5A | 15 | 22 | 20 |
| Crodafos D4A | 16 | 24 | 20 |
| Crodafos O5A | 15 | 23 | 20 |
| Crodafos T5A | 16 | 25 | 20 |
| Crodafos O10A | 16 | 20 | 19 |
| Crodafos O10D | 16 | 24 | 19 |

¹Phosphate ester surfactants are available from Croda (Edison, NJ);
²The control spray solutions contain no phosphate ester surfactant and no Omega-9 canola oil.

### Example 11

### 2, 4-D Choline and 2,4-D DMA Herbicide Concentrates Containing Built-in Omega-9 Canola Oil

Concentrate A:

An aqueous herbicide concentrate containing 383 gae/kg of 2,4-D choline, 40 g/l, of Atlox DP 13/6 surfactant (Croda; Edison, N.J.), 20 g/kg of propylene glycol (co-solvent), 9.625 g/kg of ethylenediaminetetraacetic acid choline salt, 2.5 g/kg of polymeric surfactant Atlox™ 4912 (Croda; Edison, N.J.), 19 g/kg of choline hydroxide (Aldrich) and 20 g/kg of omega-9 canola oil (Dow AgroSciences. Indianapolis, Ind.) were prepared as described. A 4-oz vial (Vial A) was first charged with 2 g of omega-9 canola oil. To the vial were added, 4.00 g of Atlox DP 13/6, 0.25 g of Atlox™ 4912, and 2.00 g of propylene glycol, and the mixture was stirred with an overhead mixer until a homogenous solution formed. To the second 4-oz vial (Vial B) were added 86.00 g of a 44.5 wt % ae basis 2,4-D choline salt solution in water, 3.85 g of an EDTA-choline aqueous solution (25 wt %), 1.90 g of choline hydroxide (45 wt %), and the ingredients in Vial A to provide a sample with a total sample of 100 g. The resulting mixture in Vial B was then mixed with an overhead agitator to provide a homogenous herbicide concentrate with built-in omega-9 canola oil.

Concentrate B:

An aqueous herbicide concentrate containing 560 gae/kg of 2,4-D DMA, 40 g/kg of Atlox DP 13/6 surfactant (Croda; Edison, N.J.), 63.5 g/kg of propylene glycol (co-solvent), 10 g/kg of ethylenediaminetetraacetic acid choline salt, 2.5 g/kg of polymeric surfactant Atlox™ 4912 (Croda; Edison, N.J.), 5.6 g/kg of dimethylamine (Aldrich) and 20 g/kg of omega-9 canola oil (Dow AgroSciences, Indianapolis, Ind.) was prepared as described. A 4-oz vial was first charged with 2 g of omega-9 canola oil. To the vial were added, 4.00 g of Atlox DP 13/6, 0.25 g of Atlox™ 4912 and 6.35 g of propylene glycol, and the mixture was stirred with an overhead mixer until a homogenous solution formed. To a second 4-oz vial were added 82.00 g of a 55.32 wt % ae basis 2,4-D DMA salt solution in water, 4.00 g of an EDTA-choline aqueous solution (25 wt %), 1.40 g of dimethylamine solution (DMA, 40 wt % in water) and the ingredients in the first vial to provide a sample with a total weight of 100 g. The mixture was then mixed with an overhead agitator to provide a homogenous herbicide concentrate with built-in omega-9 canola, oil.

TABLE 15
Compositions of 2,4-D choline and 2,4-D DMA Herbicide
Concentrates with Omega-9 Canola Oil

| | Concentrate A | Concentrate B |
|---|---|---|
| Component | (wt %) | (wt %) |
| 2,4-D Choline Solution | 86.00 | — |
| 2,4-D DMA Solution | — | 82.00 |
| Propylene glycol | 2.00 | 6.35 |
| Atlox DP 13/6 | 4.00 | 4.00 |
| EDTA-choline (25 wt %) | 3.85 | 4.00 |
| Omega-9 canola oil | 2.00 | 2.00 |
| Atlox 4912 | 0.25 | 0.25 |
| Choline OH (45 wt %) | 1.90 | — |
| DMA (40 wt %) | — | 1.40 |
| Total | 100.00 | 100.00 |

Two aqueous 2,4-D choline and 2,4-D DMA concentrates containing omega-9 canola oil and two aqueous control concentrates where the omega-9 canola oil was substituted with water were prepared in this manner.

### 2,4-D Herbicide Spray Solutions Containing Additional Herbicides and Spray Droplet Analysis

The two aqueous 2,4-D salt concentrates containing omega-9 canola oil and the two aqueous control samples were each tank-mixed with water alone (Spray solutions A in Table 16), with an aqueous solution of glyphosate salt (Spray solutions B-F in Table 16), and with an water-dispersible granule of glyphosate ammonium salt (spray solution G in Table 16). Spray solutions A containing L87% v/v of 2,4-D concentrate were prepared by diluting 5.61 mL of each of the four 2,4-D concentrates with 294.39 mL of deionized water. Spray solutions B containing 1.87% v/v of 2,4-D concentrate and 2.78% v/v of glyphosate potassium concentrate were prepared by diluting 5.61 mL of each of the four 2,4-D concentrates with 8.34 mL of RoundUp PowerMax® herbicide (containing 540 gae/L of glyphosate potassium; Monsanto; St. Louis, Mo.) and 286.05 mL of deionized water. Spray solutions C containing L87% v/v of 2,4-D concentrate and 3.125% v/v of glyphosate DMA concentrate were prepared by diluting 561 mL of each of the four 2,4-D concentrates with 9.375 mL of Durango® herbicide (containing 480 gae/L glyphosate DMA, Dow AgroSciences, Indianapolis, Ind.) and 285.015 mL of deionized water. Spray solutions D containing L87% v/v of 2,4-D concentrate and 100% v/v of glyphosate K concentrate were prepared by diluting 5.61 mL of each of the four 2,4-D concentrates with 9.00 mL of Zapp Qi® herbicide (containing 500 gae/L glyphosate K, Syngenta) and 285.39 mL of deionized water. Spray solutions E containing 1.87% v/v of 2,4-D concentrate and 3.125& v/v of glyphosate IPA concentrate were prepared by diluting 5.61 mL of each of the four 2,4-D concentrates with 9.375 mL of Transorb® herbicide (containing 480 gae/L glyphosate IPA, Monsanto; St. Louis, Mo.) and 285.015 mL of deionized water. Spray solutions F containing 1.87% v/v of 2,4-D concentrate and 3.125% v/v of glyphosate K concentrate were prepared by diluting 5.61 mL of each of the four 2,4-D concentrates with 9.375 mL of Transorb® R herbicide (containing 480 gae/L glyphosate K, Monsanto; St. Louis, Mo.) and 285.015 mL of deionized water. Spray solutions G containing 1.87% v/v of 2,4-D concentrate and 2.08 g of glyphosate ammonium water-dispersible granules were prepared by diluting 5.61 mL of each of the four 2,4-D concentrates with 6.249 g of Roundup® WDG herbicide (containing 720 gae/kg glyphosate ammonium, Monsanto; St. Louis, Mo.) and 288.144 mL of deionized water. All tank mixed spray solutions were lightly shaken by hand until each sample was homogenous. The herbicide spray solutions containing the various tank-mixed herbicides and the control samples without omega-9 canola oil were sprayed using the method described in Example 1. The percentage of driftable fines was expressed as the volume percentage of spray droplets below 150 μm volume mean diameter (VMD) as shown in Table 16.

TABLE 16
Spray Droplet Analysis of 2,4-D Herbicide Sprays
Containing Various Tank-mixed Herbicides

| | Spray Solutions A-G | | | | | | |
|---|---|---|---|---|---|---|---|
| | | | | | | F | G |
| 2,4-D Salt | | B | C | D | E | (2,4-D + | (2,4-D + |
| Concentrates | A | (2,4-D + Roundup ® | (2,4-D + | (2,4-D + Zapp | (2,4-D + | Transorb | Roundup ® |
| (wt % omega-9 | (2,4-D salt only) | Powermax) | Durango ®) | Qi ®) | Transorb ®) | R ®) | WDG) |
| canola oil) | Volume Percentage of Driftable Fines (<150 μm VMD) | | | | | | |
| 2,4-D Choline | 45 | 50 | 48 | 49 | 50 | 50 | 52 |
| control (0 wt %) | | | | | | | |
| 2,4-D Choline | 15 | 21 | 19 | 17 | 24 | 25 | 29 |
| (2 wt %) | | | | | | | |
| 2,4-D DMA | 44 | 52 | 50 | 49 | 50 | 52 | 53 |
| control (0 wt %) | | | | | | | |
| 2,4-D DMA | 18 | 31 | 27 | 23 | 31 | 33 | 47 |
| (2 wt %) | | | | | | | |

### Example 12

### 2,4-D Choline Herbicide Concentrate with Canola Oil

An aqueous herbicide concentrate containing 383 gae/kg of 2,4-D choline, 20 g/kg of Atlox DP 13/6 surfactant (Croda; Edison, N.J.), 56 g/kg of propylene glycol (co-solvent), 10 g/kg of ethylenediaminetetraacetic acid choline salt, 2.5 g/kg of polymeric surfactant Atlox™ 4912 (Croda; Edison, N.J.), 15 g/kg of polymeric surfactant (Croda; Edison, N.J.) and 20 g/kg of pure canola oil (Dow AgroSciences, Indianapolis, Ind.) was prepared as described. A 4-oz vial (Vial A) was first charged with 2 g of pure canola oil. To the vial were added, 2.00 g of Atlox DP 13/6, 0.25 g of Atlox™ 4912, 0.15 g of Atlas G-5000 and 5.60 g of propylene glycol, and the mixture formed was then stirred with an overhead mixer until a homogenous solution formed. To a second 4-oz vial (Vial B) were added 86.00 g of a 44.5 wt % ae basis 2,4-D choline salt solution in water, 4.00 g of an EDTA-choline aqueous solution (25 wt %), and the ingredient in the Vial A to provide a sample with a total weight of 100 g. The mixture (Vial B) was then mixed with an overhead agitator to provide a homogenous herbicide concentrate containing built-in pure canola oil. One aqueous 2,4-D choline concentrate containing pure canola oil and one aqueous control concentrate where the pure canola oil was substituted with water were prepared in this manner.

TABLE 17
Composition of 2,4-D Choline Herbicide
Concentrate Containing Pure Canola Oil

| Component | Wt % |
|---|---|
| 2,4-D Choline Solution | 86.00 |
| Propylene glycol | 5.60 |
| Atlox DP 13/6 | 2.00 |
| EDTA-choline (25 wt %) | 4.00 |
| Pure canola oil | 2.00 |
| Atlox 4912 | 0.25 |
| Atlas G-5000 | 0.15 |
| Total | 100.00 |

### 2,4-D Herbicide Spray Solutions Containing Pure Canola Oil and Various Herbicides, and Spray Droplet Analysis

The aqueous 2,4-D salt concentrate containing pure canola oil was tank-mixed with water alone (Spray Solutions A in Table 18), with aqueous solutions of glyphosate salts (Spray Solutions B-F in Table 18), and with a water-dispersible granule of glyphosate ammonium salt (Spray Solutions G in Table 18). In addition, two different weight ratios of 2,4-D to glyphosate and two different spray volumes in liters per hectare (L/ha) were used to prepare and apply the spray solutions (listed in Table 18). All tank mixed spray solutions were lightly shaken by hand until each sample was homogenous. The herbicide spray solutions containing various tank-mixed herbicides and the control samples without pure canola oil were sprayed using the method described in Example 1. The percentage of drillable fines was expressed as the volume percentage of spray droplets below 150 μm volume mean diameter (VMD) as shown in Table 18.

TABLE 18
Spray Droplet Analysis of 2,4-D Herbicide Sprays
Containing Pure Canola Oil and Additional Herbicides

| | | | Spray Solutions A-G¹ | | | | | | |
|---|---|---|---|---|---|---|---|---|---|
| Herbicide Application | | | | B | | | | | G |
| Rates | | | A | (2,4-D + | C | D | E | F | (2,4-D + |
| 2,4-D | Glyphosate | Spray | (2,4-D | Roundup ® | (2,4-D + | (2,4-D + | (2,4-D + | (2,4-D + | Roundup ® |
| Choline | salt | volume | alone) | Powermax) | Durango ®) | Zapp Qi ®) | Transorb ®) | Transorb R ®) | WDG) |
| (gae/ha) | (gae/ha) | (L/ha) | Volume Percentage of Driftable Fines (<150 μm VMD) | | | | | | |
| 684 | 1200 | 80 | 15 | 26 | 20 | 20 | 26 | 26 | 30 |
| 684 | 1200 | 160 | 15 | 21 | 18 | 17 | 21 | 22 | 20 |
| 684 | 720 | 80 | 15 | 21 | 20 | 17 | 22 | 24 | 24 |
| 684 | 720 | 160 | 15 | 17 | 17 | 16 | 17 | 20 | 18 |

¹Spray solutlons A-G contain pure canola oil; when the 2,4-D choline control concentrate containing no pure canola oil was used in spray solutions A-G, the volume percentages of driftable fines (<150 μm VMD) for all the sprays ranged from 43-55%.

### Example 13

### 2,4-D Choline Herbicide Concentrate Containing Canola Oil and Different Co-Solvents

An aqueous herbicide concentrate containing 383 gae/kg of 2,4-D choline, 20 g/kg of Atlox DP 13/6 surfactant (Croda; Edison, N.J.), 47.5 g/kg of a co-solvent (chosen from propylene glycol and the ethylene/propylene glycol ethers: Dowanol™ EB, Dowanol™ DPM or Dowanol™DPnP; all available from Dow Chemical; Midland, Mich.), 10 g/kg of ethylene-diaminetetraacetic acid choline salt, 2.5 g/kg of polymeric surfactant Atlox™ 4912 (Croda; Edison, N.J.), 4.5 g/kg of choline hydroxide and 20 g/kg of pure canola oil (Dow AgroSciences, Indianapolis, Ind.) was prepared as described. A 4-oz vial (Vial A) was first charged with 2 g of pure canola oil. To the vial were added, 2.00 g of Atlox DP 13/6, 0.25 g of Atlox™ 4912, 0.15 g of Atlas G-5000 and 5.60 g of the co-solvent, and the mixture formed was then stirred with an overhead mixer until a homogenous solution formed. To a second 4-oz vial (Vial B) were added $6.00 g of a 44.5 wt % ae basis 2,4-D choline salt solution in water, 4.00 g of an EDTA-choline aqueous solution (25 wt %), and the ingredients in Vial A to provide a sample with a total weight of 100 g. The mixture (Vial B) was then mixed with an overhead agitator to provide a homogenous herbicide concentrate containing built-in pure canola oil.

TABLE 18
Composition of 2,4-D Choline Herbicide
Concentrate Containing Pure Canola Oil

| Component | Wt % |
|---|---|
| 2,4-D Choline Solution | 86.00 |
| Co-solvent | 4.75 |
| Atlox DP 13/6 | 2.00 |
| EDTA-choline (25 wt %) | 4.00 |
| Pure canola oil | 2.00 |
| Atlox 4912 | 0.25 |
| Choline hydroxide (45 wt %) | 1.00 |
| Total | 100.00 |

Five aqueous 2/4-D choline concentrates containing pure canola oil and various co-solvents, and one aqueous control concentrate containing propylene glycol as the co-solvent and where the pure canola oil was substituted with water were prepared in this manner.

### 2,4-D Herbicide Spray Solutions Containing Pure Canola Oil, Various Co-Solvents and Herbicides, and Spray Droplet Analysis

The aqueous 2,4-D salt concentrates containing pure canola oil and various co-solvents were tank-mixed with water alone (Spray Solutions A in Table 19), with aqueous solutions of glyphosate salts (Spray Solutions B-F in Table 19), and with a water-dispersible granule of glyphosate ammonium salt (Spray Solutions G in Table 19). All tank mixed spray solutions were lightly shaken by hand until each sample was homogenous. The herbicide spray solutions containing the various tank-mixed herbicides and the control samples without pure canola oil were sprayed using the method described in Example 1. The percentage of driftable fines was expressed as the volume percentage of spray droplets below 150 μm volume mean diameter (VMD) as shown in Table 19.

TABLE 19
Spray Droplet Analysis of 2,4-D Herbicide Sprays
Containing Pure Canola Oil, Various Co-solvents and Additional Herbicides

| | Spray Solutions A-G¹ | | | | | | |
|---|---|---|---|---|---|---|---|
| | | B | | | | | G |
| Co-solvent Used in | A | (2,4-D + | C | D | E | F | (2,4-D + |
| 2,4-D Choline | 2,4-D | Roundup ® | (2,4-D + | (2,4-D + | (2,4-D + | (2,4-D + | Roundup ® |
| Concentrate | alone) | Powermax) | Durango ®) | Zapp Qi ®) | Transorb ®) | Transorb R ®) | WDG) |
| (4.75 wt %) | Volume Percentage of Driftable Fines (<150 μm VMD) | | | | | | |
| Propylene glycol | 14 | 25 | 20 | 19 | 25 | 24 | 29 |
| Dowanol ™ EB | 21 | 28 | 24 | 22 | 27 | 28 | 33 |
| Dowanol ™ DPM | 17 | 26 | 21 | 19 | 26 | 26 | 30 |
| Dowanol ™ DPnP | 26 | 32 | 28 | 26 | 31 | 31 | 35 |

¹Spray solutions A-G contain pure canola oil (herbicide application rates: 684 gae/ha 2,4-D choline, 1200 gae/ha glyphosate salt; spray volume 80 L/ha); when the 2,4-D choline control concentrate containing no pure canola oil was used in spray solutions A-G, the volume percentages of driftable fines (<150 μm VMD) for all the sprays ranged from 43-55%.

The present invention is not limited in scope by the embodiments disclosed herein which are intended as illustrations of a few aspects of the invention and any embodiments which are functionally equivalent are within the scope of this invention. Various modifications of the compositions and methods in addition to those shown and described herein will become apparent to those skilled in the art and are intended to fall within the scope of the appended claims. Further, while only certain representative combinations of the composition components and method steps disclosed herein are specifically discussed in the embodiments above, other combinations of the composition components and method steps will become apparent to those skilled in the art and also are intended to fall within the scope of the appended claims. Thus a combination of components or method steps may be explicitly mentioned herein; however, other combinations of components and method steps are included, even though not explicitly stated. The term comprising and variations thereof as used herein is used synonymously with the term including and variations thereof and are open, non-limiting terms.

What is claimed is:

1. An aqueous herbicide concentrate, comprising:
from 5 to 90 weight percent of a water soluble salt of a herbicide;
from 0.1 to 20 weight percent of a surfactant; and
from 0.1 to 20 weight percent of a fatty acid alkyl ester of Formula I: 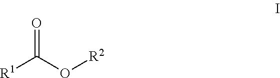
a fatty acid amide of Formula II: 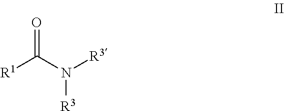
and/or a triglyceride fatty acid ester of Formula III: 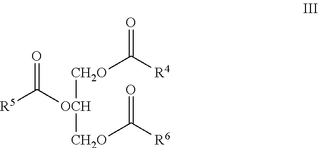
wherein R¹ represents a saturated or unsaturated straight chain (C₆-C₂₁)alkyl, R² represents a straight or branched chain (C₁-C₆)alkyl, R³ and R^{3′} independently represent hydrogen, a straight or branched chain (C₁-C₆)alkyl, or a straight or branched chain (C₁-C₆) heteroalkyl, and R⁴, R⁵, and R⁶ independently represent saturated or unsaturated (C₆-C₂₁)alkyls, and
wherein the aqueous herbicide concentrate is a transparent, homogeneous liquid that forms a stable emulsion upon dilution into a spray solution.

2. The aqueous concentrate composition of claim 1, wherein the fatty acid alkyl ester of Formula I is methyl caproate, methyl caprylate, methyl caprate, methyl laurate, methyl myristate, methyl palmitate, methyl stearate, methyl oleate, methyl linoleate, methyl linolenate, or mixtures thereof.

3. The aqueous concentrate composition of claim 1, wherein the fatty acid amide of Formula II is N,N-dimethylcaprylamide, N,N-dimethylcapramide, or mixtures thereof.

4. The aqueous concentrate composition of claim 1, wherein R³ and R^{3′} combine to form a heterocyclic group.

5. The aqueous concentrate composition of claim 4, wherein R³ and R^{3′} combine to form a morpholine group, a piperidine group, or a pyrrolidine group.

6. The aqueous concentrate composition of claim 1, wherein the triglyceride fatty acid alkyl ester of Formula III is soybean oil, rapeseed oil, olive oil, castor oil, sunflower seed oil, almond oil, canola oil, omega-9 canola oil, coconut oil, corn oil, cotton seed oil, linseed oil, palm oil, peanut oil, safflower oil, sesame oil, twig oil, or mixtures thereof.

7. The aqueous concentrate composition of claim 1, wherein the surfactant is an acid or salt of a mono or dialkyl phosphate ester, an acid or salt of an ethoxylated mono or dialkyl phosphate ester, an acid or salt of a mono or dialkyl phosphate ester of an ethoxylated tristyrylphenol, or an acid or salt of a mono or dialkyl phosphate ester of an ethoxylated phenol or an ethoxylated alkylphenol.

8. The aqueous concentrate composition of claim 1, wherein the surfactant is an ABA block copolymer having a hydrophilic portion of polyethylene oxide and a hydrophobic portion of poly(12-hydroxystearate), a polyvinyl alcohol resin wherein the degree of hydrolysis is 86-89%, a block or graft acrylate or methacrylate copolymer, an alkyd polyethylene oxide resin, or an AB block copolymer containing EO and PO blocks.

9. The aqueous concentrate composition of claim 1, wherein the herbicide is an auxinic herbicide.

10. The aqueous concentrate composition of claim 9, wherein the auxinic herbicide is a water soluble salt of 2,4-D, a water soluble salt of triclopyr, a water soluble salt of dicamba, or mixtures thereof.

11. The aqueous concentrate composition of claim 9, wherein the auxinic herbicide is a water soluble salt of 2,4-D.

12. The aqueous concentrate composition of claim 9, wherein the auxinic herbicide is 2,4-D choline salt.

13. The aqueous concentrate composition of claim 9, wherein the auxinic herbicide is 2,4-D dimethyl ammonium salt.

14. The aqueous concentrate composition of claim 9, wherein the auxinic herbicide is 2,4-D choline salt or 2,4-D dimethyl ammonium salt.

15. The aqueous concentrate composition of claim 9, wherein the auxinic herbicide is 2,4-D choline salt or 2,4-D dimethyl ammonium salt, and the fatty acid alkyl ester of Formula I is methyl caproate, methyl caprylate, methyl caprate, methyl laurate, methyl myristate, methyl palmitate, methyl stearate, methyl oleate, methyl linoleate, methyl linolenate, or mixtures thereof.

16. The aqueous concentrate composition of claim 9, wherein the auxinic herbicide is 2,4-D choline salt or 2,4-D dimethyl ammonium salt, and the triglyceride fatty acid alkyl ester of Formula III is a vegetable oil or a seed oil selected from soybean oil, rape seed oil, olive oil, castor oil, sunflower seed oil, almond oil, canola oil, omega-9 canola oil, coconut oil, corn oil, cotton seed oil, linseed oil, palm oil, peanut oil, safflower oil, sesame oil, tung oil, or mixtures thereof.

17. A method for reducing spray drift during herbicide spray application to control plant growth comprising:
providing an aqueous herbicide concentrate comprising:
from 5 to 90 weight percent of a water soluble salt of a herbicide;
from 0.1 to 20 weight percent of a surfactant;
from 0.1 to 20 weight percent of a fatty acid alkyl ester of Formula I: 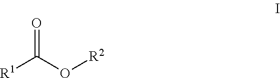
a fatty acid amide of Formula H: 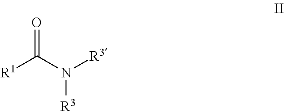
and/or a triglyceride fatty acid ester of Formula III: 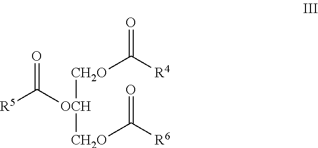
wherein R¹ represents a saturated or unsaturated straight chain (C₆-C₂₁)alkyl, R² represents a straight or branched chain (C₁-C₆)alkyl, R³ and R^{3′} independently represent hydrogen, a straight or branched chain (C₁-C₆)alkyl, or a straight or branched chain (C₁-C₆) heteroalkyl, and R⁴, R⁵, and R⁶ independently represent saturated or unsaturated (C₆-C₂₁)alkyls, and
wherein the aqueous herbicide concentrate is a transparent, homogeneous liquid that forms a stable emulsion upon addition to water;
adding the aqueous herbicide concentrate to a spray tank containing water to form the stable emulsion; and
spraying the stable emulsion to control plant growth.

18. The method of claim 17, wherein the fatty acid alkyl ester of Formula I is methyl caproate, methyl caprylate, methyl caprate, methyl laurate, methyl myristate, methyl palmitate, methyl stearate, methyl oleate, methyl linoleate, methyl linolenate, or mixtures thereof.

19. The method of claim 17, wherein the fatty acid amide of Formula II is N,N-dimethylcaprylamide, N,N-dimethylcapramide, or mixtures thereof.

20. The method of claim 17, wherein R³ and R^{3′} combine to form a heterocyclic group.

21. The method of claim 20, wherein R³ and R^{3′} combine to form a morpholine group, a piperidine group, or a pyrrolidine group.

22. The method of claim 17, wherein the triglyceride fatty acid ester of Formula III is a vegetable or a seed oil selected from soybean oil, rape seed oil, olive oil, castor oil, sunflower seed oil, almond oil, canola oil, omega-9 canola oil, coconut oil, corn oil, cotton seed oil, linseed oil, palm oil, peanut oil, safflower oil, sesame oil, tung oil, or mixtures thereof.

71. The method of claim 17, wherein the surfactant is an acid or salt of a mono or dialkyl phosphate ester, an acid or salt of an ethoxylated mono or dialkyl phosphate ester, an acid or salt of a mono or dialkyl phosphate ester of an ethoxylated tristyrylphenol, or an acid or salt of a mono or dialkyl phosphate ester of an ethoxylated phenol or an ethoxylated alkylphenol.

24. The method of claim 17, wherein the surfactant is an ABA block copolymer having a hydrophilic portion of polyethylene oxide and a hydrophobic portion of poly(12-hydroxystearate), a polyvinyl alcohol resin wherein the degree of hydrolysis is 86-89%, a block or graft acrylate or methacrylate copolymer, an alkyd polyethylene oxide resin, or an AB block copolymer containing EO and PO blocks.

25. The method of claim 17, wherein the herbicide is an auxinic herbicide.

26. The method of claim 25, wherein the auxinic herbicide is a water soluble salt of 2,4-D, a water soluble salt of triclopyr, a water soluble salt of dicamba, or mixtures thereof.

27. The method of claim 25, wherein the auxinic herbicide is a water soluble salt of 2,4-D.

28. The method of claim 25, wherein the auxinic herbicide is 2,4-D choline salt.

29. The method of claim 25, wherein the auxinic herbicide is 2,4-D dimethyl ammonium salt.

30. The method of claim 17, wherein the aqueous herbicide concentrate is added to a spray tank of water further comprising an additional herbicide.

31. The method of claim 17, wherein the additional herbicide is glyphosate or glufosinate.

32. The method of claim 31, wherein the auxinic herbicide is 2,4-D choline salt or 2,4-D dimethyl ammonium salt and the glyphosate is glyphosate dimethyl ammonium salt, glyphosate isopropyl ammonium salt, or glyphosate potassium salt.

33. The method of claim 31, wherein the auxinic herbicide is 2,4-D choline salt or 2,4-D dimethyl ammonium salt, the glyphosate is glyphosate dimethyl ammonium salt, glyphosate isopropyl ammonium salt or glyphosate potassium salt, the glufosinate salt is glufosinate ammonium salt, and the fatty acid alkyl ester of Formula I is methyl caproate, methyl caprylate, methyl caprate, methyl laurate, methyl myristate, methyl palmitate, methyl stearate, methyl oleate, methyl linoleate, methyl linolenate, or mixtures thereof.

34. The method of claim 31, wherein the auxinic herbicide is 2,4-D choline salt, the glyphosate is glyphosate dimethyl ammonium salt, and the fatty acid alkyl ester of Formula I is methyl caproate, methyl caprylate, methyl caprate, methyl laurate, methyl myristate, methyl palmitate, methyl stearate, methyl oleate, methyl linoleate, methyl linolenate, or mixtures thereof.

35. The method of claim 31, wherein the auxinic herbicide is 2,4-D choline salt or 2,4-D dimethyl ammonium salt, the glyphosate is glyphosate dimethyl ammonium salt, glyphosate isopropyl ammonium salt or glyphosate potassium salt, and the triglyceride fatty acid ester of Formula III is a vegetable oil or a seed oil selected from soybean oil, rape seed oil, olive oil, castor oil, sunflower seed oil, almond oil, canola oil, omega-9 canola oil, coconut oil, corn oil, cotton seed oil, linseed oil, palm oil, peanut oil, safflower oil, sesame oil, tung oil, or mixtures thereof.

36. The method of claim 31, wherein the auxinic herbicide is 2,4-D choline salt, the glyphosate is glyphosate dimethyl ammonium salt or glyphosate potassium salt, and the triglyceride fatty acid ester of Formula III is a vegetable oil or a seed oil selected from soybean oil, rape seed oil, olive oil, castor oil, sunflower seed oil, almond oil, canola oil, omega-9 canola oil, coconut oil, corn oil, cotton seed oil, linseed oil, palm oil, peanut oil, safflower oil, sesame oil, tune oil, or mixtures thereof.
